(19) United States
(12) Patent Application Publication
(10) Pub. No.: US 2026/0279332 A1
(43) Pub. Date: Sep. 17, 2026

(54) SYSTEM

(71) Applicant: SoftBank Group Corp., Tokyo (JP)

(72) Inventor: Ryoko KOSE, Tokyo (JP)

(73) Assignee: SoftBank Group Corp., Tokyo (JP)

(21) Appl. No.: 19/548,980

(22) Filed: Feb. 25, 2026

Related U.S. Application Data
(60) Provisional application No. 63/769,979, filed on Mar. 11, 2025.

(51) Int. Cl. G10L 13/08; G06F 16/9535; G06F 16/9537; G10L 15/08; G10L 19/02; G10L 21/0208; G10L 25/84

(52) U.S. Cl. CPC G10L 13/08; G06F 16/9535; G06F 16/9537; G10L 15/08; G10L 19/02; G10L 21/0208; G10L 25/84; G10L 2015/088

(57) ABSTRACT

A system includes a processor that is configured to control an audio collection unit configured to collect ambient audio around a user, control an audio signal processing unit configured to remove noise from the collected audio and to extract important audio from the collected audio, control a bone conduction transmission unit configured to transmit the extracted important audio directly to an inner ear of the user by bone conduction, control a position information acquisition unit configured to determine a current location of the user, and control an information provision unit configured to acquire, based on the current location of the user, at least one of weather information, traffic information, and discount information of commercial facilities in a surrounding area of the current location, and to provide the acquired information to the user.

### CROSS-REFERENCE TO RELATED APPLICATION

This application claims the benefit of U.S. Provisional Application No. 63/769,979, filed on Mar. 11, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In noisy or information-rich environments such as crowded stations, cafés, shopping malls, or construction sites, a user often cannot clearly hear important speech, such as conversations, announcements, or instructions, due to surrounding noise including background music, crowd chatter, or machinery sounds. Conventional hearing assistance devices and noise-cancelling headphones primarily focus on amplifying or filtering audio, and often block the ear canal, which can reduce the user's awareness of surrounding environmental sounds and compromise safety. Furthermore, conventional systems for providing location-based information, such as weather, traffic, or commercial promotions, typically rely on visual displays on smartphones or similar terminals, requiring active operation by the user and prior searching effort. As a result, the user must divide attention between listening to the environment and manually checking information, which can reduce convenience and efficiency in daily life.

Accordingly, there is a need for a system that can, without blocking the ear canal, selectively enhance and deliver only important audio to the user in real time even in noisy environments, while allowing the user to continue perceiving ambient sounds. There is also a need for a system that can automatically acquire and provide personalized, location-based information, such as weather, traffic, and commercial discount information, based on the user's current location and preferences, thereby reducing the user's burden of searching for necessary information and enabling more efficient daily activities.

### SUMMARY

To solve the above problems, a system is provided comprising a processor, wherein the processor is configured to control an audio collection unit configured to collect ambient audio around a user, control an audio signal processing unit configured to remove noise from the collected audio and to extract important audio from the collected audio, control a bone conduction transmission unit configured to transmit the extracted important audio directly to an inner ear of the user by bone conduction, control a position information acquisition unit configured to determine a current location of the user, and control an information provision unit configured to acquire, based on the current location of the user, at least one of weather information, traffic information, and discount information of commercial facilities in a surrounding area of the current location, and to provide the acquired information to the user. In one aspect, the processor is further configured to control the audio collection unit comprising a high-sensitivity microphone, and to control the audio signal processing unit comprising an AI processor configured to execute an audio signal processing algorithm to perform frequency-domain analysis and time-domain analysis on the collected audio, to identify and filter noise based on results of the analyses, and to perform speech recognition on the collected audio, to extract important conversation contained in the collected audio based on a result of the speech recognition, and to cause the bone conduction transmission unit to transmit the extracted important conversation to the user. In another aspect, the processor is configured to control the position information acquisition unit to determine the current location of the user by using GPS and Wi-Fi, to control the information provision unit to acquire the weather information, the traffic information, and the discount information of the commercial facilities from a cloud service and the Internet based on the current location of the user, and to control the information provision unit to customize the acquired information based on past behavioral patterns and preferences of the user, and to provide the customized information to the user to enable the user to efficiently perform daily activities.

The term “system” refers to an integrated set of hardware and software components, including at least one processor and a plurality of functional units, that cooperatively perform audio processing, position acquisition, and information provision operations for a user. The term “processor” refers to one or more hardware processing circuits, such as a CPU, GPU, DSP, or AI accelerator, that execute instructions or control signals to implement the functions of the audio collection unit, audio signal processing unit, bone conduction transmission unit, position information acquisition unit, and information provision unit.

The term “audio collection unit” refers to a hardware and/or software component configured to capture ambient audio around a user, and typically includes at least one high-sensitivity microphone and associated circuitry for converting sound waves into electrical or digital signals.

The term “ambient audio” refers to sound present in the user's surrounding environment, including speech, background music, crowd noise, machinery noise, announcements, and other environmental sounds.

The term “high-sensitivity microphone” refers to a microphone with sufficient sensitivity and signal-to-noise performance to reliably capture low-level speech and environmental sounds in noisy or dynamic environments.

The term “audio signal processing unit” refers to a hardware and/or software component configured to process collected audio signals, including performing noise reduction, speech enhancement, feature extraction, and related signal analysis operations.

The term “AI processor” refers to a processor or processing block specialized for executing artificial intelligence or machine learning algorithms, including neural network models used for audio signal processing, noise identification, and speech recognition.

The term “audio signal processing algorithm” refers to a set of computational procedures executed by the audio signal processing unit or AI processor to analyze, transform, or filter audio signals, and includes frequency-domain analysis, time-domain analysis, and noise filtering algorithms.

The term “frequency-domain analysis” refers to processing that transforms audio signals from the time domain into the frequency domain, such as by using a Fourier transform, to analyze spectral components for the purpose of identifying and separating noise and speech.

The term “time-domain analysis” refers to processing that analyzes audio signals directly as a function of time, including waveform analysis, temporal feature extraction, and segmentation of audio into frames or utterances.

The term “noise” refers to undesired audio components included in the collected audio, such as background music, crowd chatter, machinery sounds, or other non-target sounds that interfere with the perception of important speech or information.

The term “filtering” refers to operations that attenuate or remove specific components of an audio signal, such as noise, while preserving or enhancing desired components, such as speech or important sounds.

The term “important audio” refers to portions of the collected audio that are determined to be relevant to the user, including important conversation, keywords, or information-bearing speech identified by the audio signal processing unit or AI processor.

The term “speech recognition” refers to a computational process that converts spoken language contained in the audio signal into text or structured data, which can then be analyzed to identify important conversation or keywords.

The term “important conversation” refers to one or more segments of speech contained in the collected audio that are identified, based on speech recognition results and predefined criteria, as being of particular relevance to the user, such as containing specific names, project titles, instructions, or keywords.

The term “bone conduction transmission unit” refers to a hardware component configured to convert electrical or digital audio signals into mechanical vibrations and to transmit these vibrations through the user's skull or bone structure directly to the inner ear.

The term “bone conduction” refers to a method of sound transmission in which vibrations are delivered through bones of the skull to the inner ear, bypassing the ear canal and eardrum.

The term “inner ear” refers to the part of the human ear including the cochlea and associated structures, which receive sound vibrations and convert them into neural signals for auditory perception.

The term “position information acquisition unit” refers to a hardware and/or software component configured to determine the current geographic or indoor location of the user, and may utilize GPS, Wi-Fi, and other location-determining technologies.

The term “current location” refers to the present position of the user, expressed as geographic coordinates, indoor coordinates, or a similar positional representation, as determined by the position information acquisition unit.

The term “GPS” refers to a Global Positioning System or equivalent satellite-based positioning system used to determine geographic coordinates of the user.

The term “Wi-Fi” refers to a wireless local area networking technology used for communication and, in this context, also used for determining or refining the user's location based on access point information or signal characteristics.

The term “information provision unit” refers to a hardware and/or software component configured to obtain information from external or internal data sources based on the user's current location and profile, and to provide such information to the user in an appropriate format, such as audio.

The term “weather information” refers to data describing meteorological conditions related to the user's current or nearby locations, including temperature, precipitation, wind, and weather forecasts.

The term “traffic information” refers to data describing the state of transportation routes and systems, including traffic congestion, accidents, delays, and public transportation schedules relevant to the user's current or nearby locations.

The term “discount information” refers to data describing sales, promotions, coupons, or special offers provided by commercial facilities, including discount rates, applicable products or services, and validity periods.

The term “commercial facilities” refers to stores, shopping malls, restaurants, service providers, and other business establishments that offer goods or services to consumers.

The term “surrounding area” refers to a region in proximity to the user's current location, defined by a predetermined distance, area, or facility boundary, within which weather, traffic, and commercial information is considered relevant.

The term “cloud service” refers to a remote server or distributed computing infrastructure accessible via a network, which provides storage, processing, and data retrieval services used by the information provision unit.

The term “Internet” refers to a global network of interconnected computer networks used by the information provision unit to access external information sources, such as weather, traffic, and commercial data providers.

The term “past behavioral patterns” refers to historical data describing the user's previous actions, such as visited locations, accessed information, responded promotions, and interaction history with the system.

The term “preferences of the user” refers to explicit or inferred user interests, likes, dislikes, and priorities, such as favorite brands, preferred content categories, or notification settings, which are used to customize the information provided.

The term “customized information” refers to information that has been selected, filtered, and formatted based on the user's past behavioral patterns and preferences, so as to increase relevance and usefulness for the user.

The term “daily activities” refers to routine actions and tasks performed by the user in everyday life, including commuting, working, shopping, and leisure activities, which can be supported or made more efficient by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

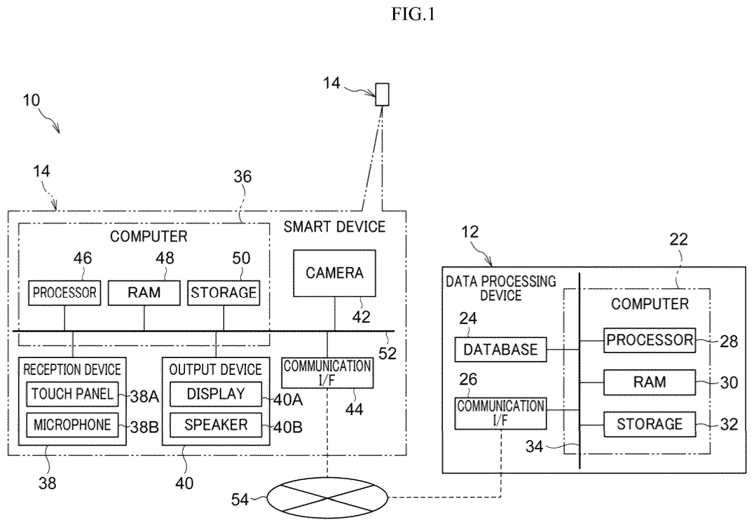

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

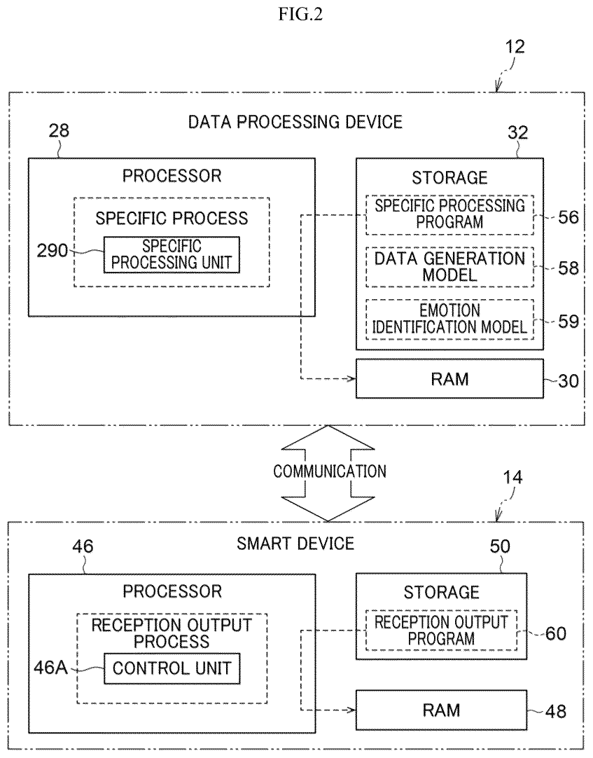

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional wearable audio systems and mobile information delivery systems suffer from several technical limitations in the way they process sensor data, filter audio, and control context-aware notifications. In many existing systems, audio enhancement, speech recognition, location determination, and information delivery are implemented as loosely coupled and largely independent functions. As a result, such systems typically apply generic noise reduction, perform speech recognition without considering user context, and push notifications based on simple location triggers. This fragmented architecture leads to inefficient use of processing resources on edge devices, increased network traffic to backend services, and suboptimal relevance and timing of delivered information.

In particular, traditional audio processing pipelines on wearable terminals often rely on fixed filtering parameters or simple spectral subtraction that do not adapt to rapidly changing noise conditions and do not exploit machine learning models running locally. These pipelines generally do not combine frame-level noise suppression with downstream keyword extraction to drive higher-level decision logic. Consequently, the terminal may either pass through excessive noise or discard portions of speech that contain user-important phrases, which degrades both intelligibility and the utility of the device in crowded or noisy environments.

Furthermore, typical location-based information systems primarily use coarse outdoor positioning based on satellite signals and simple proximity rules to trigger notifications. They do not robustly integrate indoor and outdoor positioning, movement state estimation, and historical position traces to infer a richer “position state” and “region context” for the user.

Without this deeper context, servers must either over-notify the user or risk missing meaningful opportunities, leading to an inefficient and noisy user experience.

Additionally, the generation and presentation of notifications are often governed by static templates or fixed business rules on the server. These rules do not incorporate on-device audio-derived signals such as recognized important phrases, and they do not leverage generative information processing models to adapt the content and structure of messages. As a consequence, server components frequently send verbose or poorly targeted messages, causing unnecessary cognitive load and reducing the effectiveness of the system as a whole.

From a computer-technology perspective, there is a need for an integrated technical solution that re-architects the interaction between a wearable terminal and a backend processor. Such a solution should: (i) tightly couple low-level audio signal processing, local speech recognition, and keyword extraction with higher-level context inference; (ii) combine multi-source positioning data into a unified position state and region model; and (iii) use a generative information processing model not merely to format text, but to dynamically refine ranking conditions and audio text generation based on real-time multimodal inputs. Without such an integrated architecture, conventional systems remain constrained by rigid pipelines, inefficient resource usage, and limited adaptability in real-world noisy and dynamic environments.

Accordingly, an object of the present invention is to provide an improved computer-implemented system architecture and processing flow in which a processor on a wearable or mobile device and a processor on a server cooperate to: (1) perform fine-grained noise suppression and important-speech extraction on the device, (2) generate rich position history and region information from heterogeneous sensor and network data, and (3) dynamically generate and control context-aware notifications using a generative information processing model. Another object is to reduce unnecessary data transmission and processing by allowing the processor to compute relevance scores and ranking based on locally extracted important phrases and position history, thereby improving the efficiency and technical performance of the overall computer system, including reduced bandwidth usage, improved latency, and more accurate and timely delivery of audio output via bone-conduction or similar transducers.

The specific processing by the specific processing unit 290 of the data processing device 12 in Example 1 is realized by the following means.

The present invention provides a server comprising a processor and a memory storing instructions that, when executed by the processor, cause the processor to receive, from a terminal device, position history information representing a plurality of positions, movement speeds, and movement directions of a user over time, wireless environment information associated with the user, and information indicating important phrases extracted on the terminal device from a processed speech signal in which noise components have been suppressed; determine, based on the position history information and the wireless environment information, a position state of the user including at least an indoor or outdoor classification and a region context, and generate region information corresponding to the determined position state; acquire, based on the region information, external information including environment information, movement information, and sales information from an external information source via a network, and temporarily store the acquired external information in the memory; calculate, for each piece of the acquired external information, a relevance value based on at least the position history information, the important phrases, and use history information of the user stored in the memory, rank the acquired external information according to the relevance value, and select presentation target information; create a generation instruction sentence including an input sentence that describes the position state of the user, the important phrases, and the acquired external information, transmit the generation instruction sentence to a generative information processing model executed locally or by a remote computation resource, obtain a response sentence generated by the generative information processing model, and, based on the response sentence, update at least one of text for audio output corresponding to the presentation target information and a ranking condition used in the ranking; and transmit, to the terminal device, the text for audio output and control information indicating at least a priority and a timing for output of a notification corresponding to the presentation target information. This enables an improved computer-implemented processing flow in which the server cooperates with the terminal device to integrate audio-derived important phrases, rich position state, and user history into a unified relevance computation and generative-model-based text generation process, thereby technically enhancing the efficiency, adaptability, and context-sensitivity of information delivery, reducing unnecessary network traffic and processing load, and improving the timing and relevance of audio notifications output to the user.

The term “processor” refers to an electronic data processing unit, such as a central processing unit or a dedicated signal processing unit, that executes machine-readable instructions to perform arithmetic and logical operations on data.

The term “storage medium” refers to any physical storage resource, including volatile memory and non-volatile memory, that is configured to store electrical signals, digital data, or instructions for access by a processor.

The term “electrical signal” refers to an analog or digital representation of sound or other information encoded as a variation of voltage, current, or charge over time.

The term “surrounding environment” refers to a physical space in proximity to a user in which sound, wireless signals, or other detectable phenomena are present and can be sensed by a device.

The term “short-time analysis” refers to a signal processing operation in which a time-series signal is segmented into frames of finite duration and each frame is analyzed independently in at least one of a time domain and a frequency domain.

The term “noise component” refers to a part of a signal that is determined not to correspond to a target speech signal and that is treated as an unwanted artifact to be suppressed or removed.

The term “speech component” refers to a part of a signal that is determined to correspond to spoken utterances intended to be preserved, enhanced, or recognized.

The term “processed speech signal” refers to a speech-related signal that has been transformed from an original signal by at least one processing operation, including noise suppression, emphasis, or filtering, to improve intelligibility or suitability for further processing.

The term “speech section” refers to a segment of a signal identified as containing speech content, delimited in time by start and end points.

The term “speech recognition processing” refers to a computational procedure that converts a speech section into a symbolic representation, such as text or a token sequence, by using acoustic analysis and a recognition model.

The term “phrase group” refers to a collection of words, phrases, or linguistic patterns stored in a memory to be used as references for detecting important phrases in recognized text.

The term “important phrase” refers to at least one word or phrase included in a phrase group and determined to have a higher relevance for subsequent processing or notification, and that is detected in recognized speech.

The term “important speech” refers to a speech section that has been classified as significant based on inclusion of at least one important phrase or other priority criteria.

The term “vibration signal” refers to a signal used to drive a transducer so as to generate mechanical vibrations capable of being transmitted through a solid medium, such as a bone of a user, to an inner ear.

The term “satellite positioning signal” refers to a radio frequency signal transmitted from a satellite-based navigation system and used to determine a geographic position of a device.

The term “wireless communication signal” refers to an electromagnetic signal transmitted through free space by a wireless communication system, such as a cellular system or a local wireless network system, and received by a device.

The term “inertial sensor” refers to a sensing element, such as an accelerometer, a gyroscope, or a magnetometer, that measures motion or orientation of a device.

The term “position history information” refers to data representing a plurality of positions, movement speeds, and movement directions of a user or device over time.

The term “wireless environment information” refers to data indicating characteristics of wireless signals received in a region, including identifiers, signal strengths, or quality metrics of wireless access points or base stations.

The term “position state” refers to a state descriptor that characterizes a current or recent position of a user or device, including at least one of an indoor or outdoor classification, a floor level, a zone, or a region label.

The term “region information” refers to information that identifies or describes a spatial region associated with a position state, such as an area in which a user is located or is expected to move.

The term “external information source” refers to a network-accessible system, service, or database from which environmental, movement, sales, or other information can be obtained via a communication network.

The term “environment information” refers to data representing external environmental conditions, such as weather, temperature, or congestion status, associated with a region.

The term “movement information” refers to data representing transportation status or flow, such as traffic conditions, transit schedules, or delays, associated with a region.

The term “sales information” refers to data representing commercial offerings, such as discounts, promotions, or product availability, associated with vendors in a region.

The term “relevance value” refers to a numerical or ordinal score representing a degree of relationship between a piece of acquired information and at least a position history, an important phrase, or user history.

The term “ranking” refers to an ordering of a plurality of items based on associated relevance values or other priority metrics.

The term “use history information” refers to data representing past interactions or behaviors of a user with respect to devices, services, or content, including at least past selections, dismissals, purchases, or movements.

The term “presentation target information” refers to one or more pieces of acquired information that have been selected, based on ranking or other criteria, to be presented to a user.

The term “text for audio output” refers to a textual representation prepared for conversion into audio signals by a text-to-speech process or related synthesis method.

The term “generation instruction sentence” refers to an instruction including text that describes an input condition or context, transmitted to a generative information processing model to cause generation of a response sentence.

The term “input sentence” refers to at least one natural-language or structured expression included in the generation instruction sentence that encodes a position state, important phrases, or acquired information.

The term “generative information processing model” refers to a trained computational model, such as a probabilistic or neural network model, configured to generate a response sentence based on an input sentence and learned parameters.

The term “response sentence” refers to text generated by a generative information processing model in response to a generation instruction sentence.

The term “ranking condition” refers to at least one rule, parameter, threshold, or weighting factor used in a process of ranking acquired information.

The term “machine learning model” refers to a computer-implemented model having parameters learned from training data, configured to output at least one prediction, classification, or weight based on an input feature.

The term “time-window processing” refers to an operation of applying a window function over successive segments of a time-series signal to form finite-length frames for further analysis.

The term “short-time frequency-domain transformation” refers to a process of converting time-domain frames of a signal into corresponding frequency-domain representations, including at least a short-time Fourier transform.

The term “noise-suppression mask” refers to a set of weight values for time-frequency regions used to attenuate noise components and preserve speech components when applied to a frequency-domain representation of a signal.

The term “external information” refers to information obtained from an external information source, including but not limited to environment information, movement information, and sales information.

The term “template sentence” refers to a predefined sentence pattern including one or more variable fields to be filled with data values in order to generate a complete sentence.

The term “notification” refers to information that is selected for presentation to a user and that may be output in at least one of an audio, visual, or haptic format.

The term “behavior schedule information” refers to data representing planned or predicted activities of a user, including scheduled times, locations, or events.

The term “importance” refers to a measure of priority or significance assigned to a notification or information item, used for determining order or timing of output.

The term “load on the user” refers to an estimated level of cognitive or attentional demand placed on a user at a time, derived from at least position state, movement state, or interaction state.

In one embodiment, the system includes a terminal worn by a user and a server connected to the terminal via a communication network. The terminal includes at least one processor, a storage medium, a microphone, a bone-conduction transducer, a satellite positioning unit, a wireless communication unit, and an inertial sensor. The server includes at least one processor, a storage medium, and a network interface. The terminal and the server execute programs stored in their respective storage media to implement the functions described below.

The terminal uses a microphone having directional characteristics to acquire sound in a surrounding environment and to convert the acquired sound into an electrical signal. The terminal uses an analog-to-digital converter (ADC) integrated in a system-on-chip, such as a general mobile application processor including a digital signal processing unit, to sample the analog electrical signal at a predetermined sampling rate, for example 16 kHz or 48 kHz, and to store the sampled data as linear pulse-code modulation (PCM) values in a ring buffer in a random access memory. The terminal tags each frame of PCM values with a timestamp obtained from a system clock.

The terminal uses a processor executing a signal processing program to segment the PCM values into fixed-length frames, for example 20 milliseconds per frame with 10 milliseconds overlap, and to apply a window function such as a Hamming window to each frame. The terminal uses a short-time Fourier transform (STFT) routine, implemented by a fast Fourier transform (FFT) library executable on the digital signal processing unit, to obtain complex-valued frequency-domain coefficients for each frame. The terminal stores magnitude spectra and phase spectra as structured arrays in the random access memory. These spectra form feature vectors for subsequent processing.

The terminal uses a machine learning model to distinguish a noise component from a speech component in the feature vectors. In one example, the terminal stores a denoising neural network having an encoder-decoder architecture with skip connections, such as a convolutional U-Net, serialized in a compact runtime format suitable for execution on a neural processing unit. The terminal feeds a log-power spectrum sequence of a plurality of consecutive frames, for example 10 to 20 frames, as a two-dimensional matrix of size (frequency bins×time steps) into the neural network. The neural network outputs a real-valued mask matrix of the same size, with each element within a range from 0 to 1 representing a weight for the corresponding time-frequency bin.

The terminal multiplies each complex STFT coefficient by the corresponding mask value to suppress the noise component and to emphasize the speech component. The terminal then uses an inverse short-time Fourier transform and overlap-add synthesis to reconstruct a processed speech signal in the time domain. The terminal stores the processed speech signal in a separate buffer. This combination of frame-based STFT, learned mask generation by the neural network, and overlap-add reconstruction improves noise suppression accuracy and reduces musical noise artifacts compared to simple spectral subtraction, thereby improving speech intelligibility in highly dynamic noise environments.

The terminal uses a voice activity detection module to detect a speech section within the processed speech signal. In one example, the terminal uses a recurrent neural network, such as a bidirectional long short-term memory (LSTM) network, trained on frame-level features including log-Mel spectrogram values and energy to output a probability of speech presence for each frame. The terminal applies a threshold and a minimum duration rule to merge consecutive frames to form a speech section with start and end times. This data structure reduces computational complexity of subsequent recognition operations by filtering out non-speech segments.

The terminal uses an automatic speech recognition engine to perform speech recognition processing on the detected speech section. The terminal computes Mel-frequency cepstral coefficients (MFCCs) or log-Mel filterbank features from the processed speech signal and inputs feature sequences into a recognition model, such as a hybrid acoustic-language model or an end-to-end model including an encoder and a decoding network. The recognition model generates a token sequence representing recognized text and confidence scores for each token.

The terminal uses a phrase group stored in the storage medium, for example as a list of keywords and phrases associated with identifiers and priority levels, and scans the recognized text for matches to elements of the phrase group. When the terminal detects a match, the terminal labels the corresponding portion of the speech section as important speech, and records an important phrase event with a timestamp, the matched phrase identifier, and a priority level.

The terminal uses a bone-conduction transducer to output important speech to an inner ear of the user. The terminal converts the processed speech signal representing important speech into a vibration signal by using a digital-to-analog converter and an audio amplification circuit.

The terminal mounts the bone-conduction transducer on a frame that contacts a bone portion, such as a temporal bone, of the user. The terminal monitors an ambient sound level by using the microphone and an energy estimation algorithm and dynamically adjusts a gain parameter of an automatic gain control circuit. This configuration enables the terminal to provide intelligible audio output without occluding the ear canal and without excessively increasing output volume in quiet environments, thereby improving both safety and power efficiency.

The terminal obtains position history information by using a satellite positioning unit, a wireless communication unit, and an inertial sensor. The terminal obtains satellite positioning signals, such as signals from a global navigation satellite system, and calculates latitude, longitude, and accuracy estimates. The terminal also scans for wireless communication signals, such as signals from wireless access points or base stations, and measures their signal strengths and identifiers. The terminal further reads motion information, including acceleration and angular velocity, from the inertial sensor. The terminal fuses these data using a filter algorithm, such as an extended Kalman filter, to compute a position, a movement speed, and a movement direction for the user and to store this information in a time-stamped position history log. The terminal thereby provides more reliable and fine-grained position history information, including indoor and outdoor transitions, compared to systems that rely only on satellite signals.

The server receives the position history log, the wireless environment information, and the important phrase events from the terminal via a secure communication channel established by a transport layer security protocol. The server stores the received data in a database, such as a relational database or a document store, using data structures that relate each record to a user identifier and a timestamp. The server computes a position state of the user by analyzing patterns in the position history and in the wireless environment. For example, the server uses a classifier that maps combinations of satellite signal availability, wireless access point identifiers, and vertical motion detected in the position history to states such as “indoor mall, second floor, near fashion zone” or “outdoor transit station platform”.

The server generates region information by associating the position state with predefined regions stored in a region table. Each region may be defined by geometric boundaries, such as polygons in a coordinate system, and by semantic attributes, such as type of facility and typical noise characteristics. The server uses the region information to query external information sources over the network. For example, the server accesses an environmental information service to obtain current weather conditions for the region, accesses a transportation information service to obtain movement information such as congestion and delay data, and accesses a commercial information service to obtain sales information such as promotions and discounts from vendors located in the region. The server temporarily stores the retrieved external information in memory.

The server calculates a relevance value for each piece of external information by using a relevance computation module. The server inputs feature vectors to a machine learning model, such as a gradient boosting classifier or a neural network, where each feature vector includes elements such as distance between the user's current position and a location associated with the external information, temporal proximity between the current time and a time window of the external information, occurrence counts of related important phrases in the recent past, and usage history values such as whether the user has previously responded positively to similar information. The model outputs a relevance score between 0 and 1. The server ranks the external information items according to the relevance scores and selects a subset of items having scores above a threshold or within a predetermined top range as presentation target information. This procedure reduces the amount of information transmitted to the terminal and concentrates processing resources on high-value items, thereby improving both communication efficiency and user relevance.

The server generates text for audio output corresponding to the selected presentation target information. In one mode, the server fills predefined template sentences stored in the memory with parameters such as region name, discount percentage, and expiration time. In another mode, the server uses a generative information processing model, such as a large-scale language model hosted on a computation resource, to generate flexible natural-language descriptions of the presentation target information.

The server creates a generation instruction sentence comprising an input sentence describing the position state of the user, the important phrases, and the acquired external information. An example prompt sentence is:

“Explain, in less than 20 words, a concise audio message for a wearable device user who is currently in a shopping mall on the second floor near sports stores, where a nearby store is offering 30% off on running shoes today.”

Another example prompt sentence is:

“Generate a short notification for a commuter passing through a noisy train station, indicating that a train on the current line is delayed by 5 minutes and suggesting an alternative route.”

The server transmits the generation instruction sentence to the generative information processing model via an application programming interface. The model returns a response sentence. The server evaluates the length and content of the response sentence against safety and length constraints and, if acceptable, stores the sentence as the text for audio output corresponding to the respective piece of presentation target information. Additionally, the server may use meta-information from multiple response sentences to adjust ranking conditions, for example by increasing the weight of certain features if messages relating to particular categories are repeatedly generated or accepted by the user.

The server transmits the text for audio output together with control parameters, such as priority levels and recommended output timings, to the terminal. The terminal receives these data and stores them in a message queue. The terminal determines an appropriate output timing based on a current movement state and an estimated load on the user. For example, the terminal may delay output of low-importance promotional messages while the user is rapidly moving, and may prioritize safety-related or time-critical messages even during movement.

The terminal converts the text for audio output into synthetic speech using a text-to-speech engine implemented in software executed on the processor. The engine generates PCM waveforms with a sampling rate and bit depth compatible with the audio subsystem. The terminal mixes the synthetic speech waveform with the processed speech signal containing important speech from the environment, using an audio mixing routine that enforces maximum amplitude constraints and may attenuate background speech components while high-priority notifications are being output. The terminal supplies the mixed signal to the digital-to-analog converter and the bone-conduction transducer. As a result, the user can simultaneously receive important environmental speech and context-aware system notifications without visual interaction and without occluding the ear canal.

This integrated architecture improves computer technology in several ways. The terminal performs local, frame-based noise suppression using a trainable mask-generation network rather than a fixed filter, thereby reducing computation for the server and lowering network usage because the terminal transmits only compact important phrase events and position history information instead of raw audio streams. The coupling of local speech processing and server-side relevance computation enables a more precise and efficient filtering of notifications, thereby reducing the number and size of messages that must be processed and transmitted. The use of structured position history and region information, along with a learned relevance model, allows the server to focus computation on a small subset of highly relevant messages, reducing overall processing load and improving latency.

In addition, the cooperation between the server and the generative information processing model is not a mere automation of human drafting of messages. The server uses the response sentence to update ranking conditions and text-generation constraints, which changes how data structures are prioritized and navigated in the system, and which optimizes storage and transmission behavior. This feedback loop modifies internal weighting factors used in relevance computation and in message scheduling, thereby providing a technical effect on system throughput and error rates. For example, by adjusting thresholds and weights based on generated messages and subsequent user behavior, the server can decrease the frequency of ignored notifications and increase the ratio of acted-upon notifications, which in turn decreases wasted processing cycles and bandwidth.

The system can be implemented in variations. In one alternative embodiment, the terminal executes a smaller generative information processing model locally for certain types of messages, reducing round-trip latency to the server. In another embodiment, the server uses different neural architectures for noise suppression and relevance scoring, such as a temporal convolutional network for speech enhancement and a transformer-based model for ranking, while maintaining the same data flow and control logic described above. In yet another embodiment, the inertial sensor includes additional degrees of freedom, and the position state classifier distinguishes additional context states, such as “escalator”, “elevator”, or “vehicle”, allowing further refinement of notification timing and content.

The terminal, the server, and the generative information processing model thus cooperate in a non-conventional, rule-driven manner that combines specific data structures, feature extraction pipelines, neural network architectures, and control logic. This cooperation results in improved noise suppression accuracy, improved speech recognition stability in noisy environments, reduced network traffic due to selective data transmission, optimized use of computational resources on both the terminal and the server, and more accurate and timely delivery of audio notifications to the user through bone-conduction or similar physical output mechanisms.

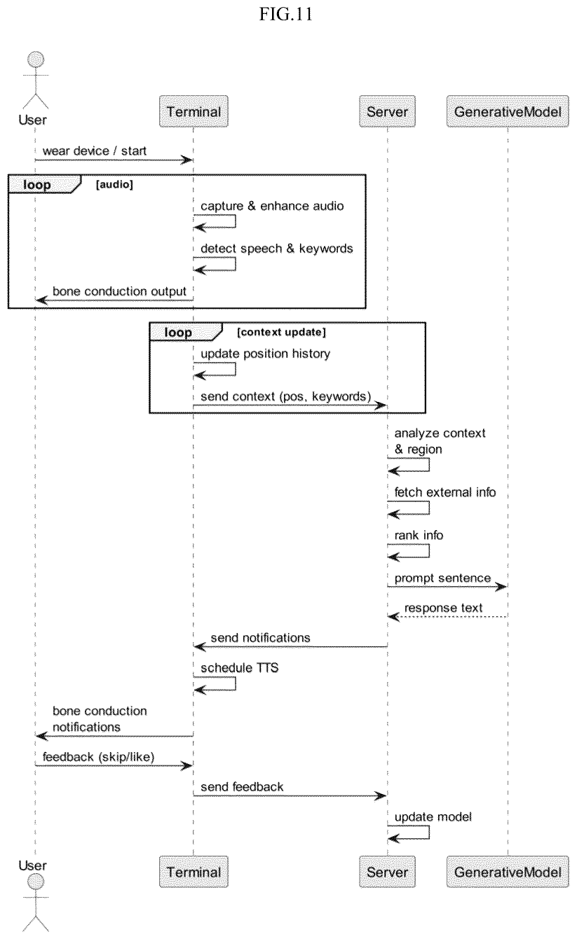

The following describes the processing flow using FIG. 11.

### Step 1

The terminal acquires ambient audio.

The terminal uses the microphone as an input device to capture sound pressure waves in the surrounding environment and converts them into an analog electrical signal. The terminal then uses an analog-to-digital converter as a hardware component to sample the analog signal at a predetermined sampling rate, for example 16 kHz, and with a predetermined bit depth, for example 16 bits. The terminal outputs a sequence of digital samples and stores them as PCM data in a ring buffer in memory, together with timestamps obtained from a system clock. The terminal thereby transforms continuous analog sound into discrete, time-stamped digital audio frames suitable for further processing.

### Step 2

The terminal performs frame segmentation and spectral transformation.

The terminal uses the PCM samples from the ring buffer as input and divides the continuous sample stream into overlapping frames, for example 20 milliseconds per frame with 10 milliseconds overlap. The terminal applies a window function, such as a Hamming window, to each frame to reduce spectral leakage. The terminal then performs a short-time Fourier transform on each windowed frame using a fast Fourier transform routine. The terminal outputs, for each frame, a vector of complex frequency-domain coefficients and stores magnitude and phase as separate arrays. The terminal thus converts time-domain data into a time-frequency representation that is more suitable for noise suppression and feature extraction.

### Step 3

The terminal generates a noise-suppression mask using a machine learning model.

The terminal takes as input a stack of magnitude spectra from a sequence of consecutive frames, forming a two-dimensional matrix (frequency bins× time steps). The terminal normalizes the matrix using precomputed mean and variance parameters and feeds the normalized matrix into a neural network model stored in memory, for example a convolutional encoder-decoder network. The terminal applies the learned weights and activation functions to compute an output matrix of mask values between 0 and 1 for each time-frequency bin. The terminal outputs this mask matrix and stores it in memory aligned with the corresponding STFT frames. By computing the mask on the time-frequency representation, the terminal prepares per-bin attenuation factors that will selectively suppress noise components while preserving speech components.

### Step 4

The terminal applies the mask and reconstructs a processed speech signal.

The terminal uses as input the complex STFT coefficients from Step 2 and the noise-suppression mask from Step 3. For each time-frequency bin, the terminal multiplies the complex coefficient by the corresponding scalar mask value, thereby attenuating bins with low mask values and retaining bins with high mask values. The terminal then performs an inverse short-time Fourier transform on the masked coefficients for each frame and applies overlap-add synthesis using the original frame shift. The terminal outputs a processed time-domain waveform in which background noise is reduced and speech is emphasized, and stores this waveform in a processed audio buffer. This operation performs a data transformation from noisy audio samples into enhanced audio samples with improved signal-to-noise ratio.

### Step 5

The terminal detects speech sections using voice activity detection.

The terminal uses the processed audio buffer as input and computes frame-level features, such as short-term energy, zero-crossing rate, and log-Mel filterbank values, for each frame. The terminal feeds these features into a voice activity detection algorithm, which may be a rule-based threshold detector or a small recurrent neural network, to compute a speech presence probability for each frame. The terminal compares the probability to a threshold and groups consecutive frames above the threshold into a speech section with a start time and an end time. The terminal outputs a list of speech sections, each associated with an index range in the processed audio buffer. This reduces subsequent computation by limiting recognition to frames that likely contain speech.

### Step 6

The terminal performs speech recognition and extracts important phrases.

The terminal uses the speech sections from Step 5 as input and, for each speech section, computes acoustic features such as MFCCs or log-Mel spectrograms over the section. The terminal feeds the feature sequence into an automatic speech recognition model, which may be an encoder-decoder network or a hybrid acoustic-language model, and executes matrix multiplications and non-linear activations according to stored model parameters to generate a sequence of tokens representing recognized text, together with confidence values. The terminal retrieves a phrase group from memory, for example a list of keywords such as product names, project names, or alert words, and scans the recognized text for occurrences of any phrase in the phrase group using string matching or token-level matching. The terminal outputs, for each detected phrase, an important phrase event containing the phrase identifier, the time position within the speech section, and a priority level, and records the associated speech section as important speech. This transforms a continuous speech signal into structured text and event data that can drive later relevance computations.

### Step 7

The terminal generates a bone-conduction output waveform for important speech.

The terminal uses important speech sections and the processed speech waveform as input. For each important speech section, the terminal extracts the corresponding segment from the processed audio buffer and may apply dynamic range compression or equalization to match the characteristics of bone-conduction transmission. The terminal converts the digital samples into analog values using a digital-to-analog converter, and controls an audio amplifier to drive a bone-conduction transducer mounted on the user's head. The terminal monitors ambient noise level via the microphone and adjusts a gain parameter in an automatic gain control module by computing a control signal based on the difference between target and measured levels. The terminal outputs a vibration signal to the transducer that delivers enhanced important speech to the inner ear of the user, while keeping total power and peak amplitude within predefined safety limits.

### Step 8

The terminal acquires and updates position history information.

The terminal uses positioning signals and motion sensor data as input. The terminal periodically reads satellite positioning signals via a positioning chipset and calculates latitude, longitude, and an accuracy estimate using a positioning algorithm. The terminal concurrently scans for wireless communication signals, measuring identifiers and signal strengths of nearby wireless access points or base stations, and reads acceleration and angular velocity from the inertial sensor. The terminal fuses these measurements using a filter algorithm, such as an extended Kalman filter, to estimate a position vector, a movement speed, and a movement direction at each sampling time. The terminal appends these estimates, together with timestamps and wireless environment snapshots, to a position history list in memory.

The terminal outputs updated position history information that characterizes the user's movement over time.

### Step 9

The terminal transmits condensed context data to the server.

The terminal uses as input the position history information, the important phrase events from Step 6, and device state information such as battery level. The terminal packages these data into a structured message, for example a JSON-like object, containing user identifiers, timestamped position entries, wireless environment indicators, and a list of important phrase events. The terminal compresses the message if necessary, initiates a secure network connection using a communication stack, and transmits the message to the server via a network interface. The terminal outputs network packets containing only condensed context data instead of raw audio, thereby reducing communication load.

### Step 10

The server ingests terminal data and determines a position state.

The server uses the received condensed context data as input. The server parses the structured message, validates field formats, and stores the position history entries and important phrase events in a database with appropriate indices. The server then analyzes the recent portion of the position history, together with associated wireless environment information, using a classifier or a rule set. For example, the server checks satellite signal availability, patterns of wireless identifiers, and vertical motion to assign a label such as “indoor mall, second floor” or “outdoor station platform”. The server outputs a position state object containing an indoor/outdoor flag, a region label, and possibly a floor or zone identifier, which is stored and used as a basis for subsequent region-based processing.

### Step 11

The server generates region information and retrieves external information.

The server uses the position state from Step 10 as input and consults a region definition table in memory. The server maps the position state to one or more region identifiers, such as zones within a facility or geographic cells in a city grid. The server then constructs queries to various external information sources based on these region identifiers, such as weather services, transportation services, and commercial information services. The server sends these queries via a network interface and receives responses containing environment information, movement information, and sales information. The server normalizes and merges these responses into a unified data structure containing external information items, each annotated with a region, a time validity, and a category. The server outputs a set of candidate external information items associated with the current position state.

### Step 12

The server computes relevance values and selects presentation target information.

The server uses as input the candidate external information items, the position history stored in the database, the important phrase events, and use history information such as past user interactions. The server constructs a feature vector for each candidate item, including numerical values representing distance from the user, recency of updates, overlap with recently detected important phrases, and prior success metrics. The server feeds these feature vectors into a machine learning model stored in memory, such as a neural network with fully connected layers, and executes forward propagation to compute a relevance score for each item. The server ranks the items by their relevance scores and filters out items below a threshold or beyond a maximum count. The server outputs a subset of items as presentation target information, each with an associated relevance score and preliminary priority level.

### Step 13

The server generates text for audio output using templates or a generative AI model.

The server uses the selected presentation target information and the position state as input. In a template mode, the server fills variable fields in pre-stored sentence patterns with parameters from each item, generating short text strings such as “On the second floor, a nearby store offers 30 percent off on running shoes today.” In a generative mode, the server constructs a generation instruction sentence (prompt sentence) that describes the user's position state, recent important phrases, and the selected information, and transmits this sentence to a generative AI model via an application programming interface. The server receives a response sentence generated by the model, checks its length and content against constraints, and accepts it as text for audio output. The server may also analyze aggregated response features to adjust internal ranking conditions for future selections. The server outputs, for each selected item, finalized text for audio output and associated control metadata, such as importance and suggested timing.

### Step 14

The server transmits notification data to the terminal.

The server uses the text for audio output and control metadata from Step 13 as input and constructs a response message including a list of notifications, each with a unique identifier, text content, priority level, and timing hints. The server optionally compresses the message, sends it over a secure network channel to the terminal, and records send timestamps and identifiers in a log table for later analysis. The server outputs network packets that carry only the processed and prioritized notification data, thereby offloading audio generation and output-timing decisions to the terminal.

### Step 15

The terminal schedules and synthesizes audio notifications.

The terminal uses the notification data from the server as input and inserts each received notification into a local message queue, associating it with its priority and recommended timing. The terminal reads current movement state and load estimates, derived from position and inertial data, and decides when to output each notification by comparing priority levels against thresholds and by avoiding conflicts with ongoing high-priority playback. When the terminal selects a notification for output, the terminal feeds the text content into a text-to-speech engine implemented in software on the processor. The engine converts the text into a PCM waveform by applying linguistic analysis, prosody generation, and acoustic synthesis based on stored model parameters. The terminal then mixes the synthesized notification waveform with the processed speech signal from Step 4, applying gain settings that may duck background speech while the notification is spoken. The terminal outputs the mixed signal to the digital-to-analog converter and the bone-conduction transducer, thereby delivering context-aware audio notifications to the user in real time.

### Step 16

The user provides feedback and implicitly trains the system.

The user uses the terminal as an interactive device by listening to bone-conduction output and by optionally operating physical or gesture-based controls. The user may tap a housing, press a button, or speak a short command to indicate actions such as “skip”, “repeat”, or “not interested”. The terminal detects these interactions using button input circuits, accelerometer patterns, or voice-command recognition and records feedback events containing notification identifiers and feedback types. The terminal transmits these feedback events to the server together with periodic context data. The server uses these events as labeled data points to update use history information and to retrain or fine-tune the relevance model, for example by adjusting model weights using gradient-based optimization with a loss function that penalizes notifications frequently skipped or rejected. The server outputs updated model parameters that are deployed to the relevance computation module, thereby closing a feedback loop that refines selection and ranking and improves notification accuracy and system efficiency over time.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional assistive systems that provide safety guidance, reminders, or environmental notifications to users, such as elderly users or users requiring care, typically rely on simple rule-based processing, fixed audio prompts, and coarse location information. These systems suffer from several technical limitations in terms of computer technology. First, traditional audio processing pipelines on embedded devices are not configured to dynamically control microphone directivity based on user motion and to selectively capture high-priority acoustic events in real time. As a result, processing resources are wasted on low-value background noise, and important acoustic events such as alarms, staff calls, or help-requesting utterances may not be robustly detected in noisy environments. Second, conventional systems often treat audio analysis, location estimation, and notification generation as separate subsystems, without a unified context model. They fail to effectively fuse time-synchronized acoustic features, position information, user schedule information, and user health information into a coherent machine-interpretable state. This leads to sub-optimal decisions in the software logic and prevents precise, situation-aware control of guidance messages.

Third, existing notification mechanisms typically rely on static, pre-recorded messages. These messages are not adapted to the current risk level, user history, or cognitive ability, and they do not leverage advances in generative AI models that can dynamically generate natural language text from rich contextual input. Conventional systems, therefore, do not provide a systematic way for a processor to construct structured prompt sentences, control prompt content and complexity, and consistently obtain safe, concise, and personalized guidance outputs from a generative AI model.

Fourth, many prior art solutions are not optimized as computer systems for continuous real-time operation. They lack mechanisms for filtering and prioritizing incoming sensor data, adaptively adjusting model invocation frequency, or automatically tuning message length and timing based on historical reaction data. Consequently, computational resources such as CPU cycles, memory bandwidth, and network bandwidth are inefficiently used, leading to scalability and latency problems when attempting to process multiple users or complex environments.

Accordingly, there is a need for improvements in computer technology, specifically for a server-client system in which a processor executes integrated audio processing, multimodal context aggregation, prompt generation, and generative AI interaction. Such a system should (i) reduce unnecessary processing by focusing on high-priority acoustic events, (ii) improve the accuracy and robustness of situation assessment through joint use of audio, location, and user profile data, and (iii) automatically generate and deliver adaptive, personalized guidance messages via bone-conduction output in real time, thereby enhancing both the functional performance of the computing system and the technical quality of human-machine interaction.

The specific processing by the specific processing unit 290 of the data processing device 12 in Application Example 1 is realized by the following means.

The present invention provides a server comprising a processor configured to acquire, from a terminal device, acoustic signals captured by a dynamically controlled directional acoustic sensor and position information estimated from satellite positioning data and wireless communication data, to perform noise suppression, acoustic event detection, speaker identification, and speech recognition on the acoustic signals so as to extract high-priority speech information and acoustic event information, to associate the extracted information with the position information and at least one of schedule information and health information of a user to generate machine-readable context data, to construct a prompt sentence in a natural language by embedding the context data as input conditions, to supply the prompt sentence to a generative AI model and obtain, from the generative AI model, a guidance text personalized to a current situation of the user, and to output, toward the terminal device, the guidance text or an audio signal generated from the guidance text for bone-conduction presentation to the user. This enables improvement of operation of the computer system itself by reducing redundant signal processing through context-aware prioritization of acoustic events, by enhancing accuracy and robustness of situation assessment through integrated multimodal context generation, and by automatically producing adaptive, personalized guidance messages via managed interaction with the generative AI model, thereby achieving lower latency, more efficient use of computational and network resources, and technically superior real-time assistance behavior compared to conventional rule-based notification systems.

The term “acoustic signal” refers to digital or analog data representing sound pressure variations in the environment, including speech, environmental noise, alarms, and other sound events.

The term “acoustic sensor” refers to a hardware component such as a microphone or microphone array that converts sound waves in the environment into an electrical signal for processing by the processor.

The term “directionality characteristic” refers to a spatial sensitivity pattern of the acoustic sensor that determines from which directions sound is preferentially captured or attenuated.

The term “motion state of the user” refers to physical movement information of the user, including at least one of posture, orientation, speed, and acceleration, obtained by sensors such as inertial sensors or derived from location changes over time.

The term “noise suppression processing” refers to signal processing operations, including statistical or model-based algorithms, that reduce or remove undesired background components from the acoustic signal while preserving useful speech or sound events.

The term “acoustic event detection processing” refers to analysis of the acoustic signal using classification models or rule-based logic in order to identify specific sound categories such as alarms, calls, or help-requesting utterances.

The term “speaker identification processing” refers to processing that extracts speaker-specific features from the acoustic signal and determines an identity or class of the speaker, such as a particular user, staff member, or unknown speaker.

The term “speech recognition processing” refers to automatic conversion of spoken language contained in the acoustic signal into corresponding text data by using acoustic and language models.

The term “high-priority speech information” refers to portions of recognized speech that have been classified as important for safety, guidance, or support of the user, based on predefined rules or model outputs.

The term “acoustic event information” refers to metadata describing detected sound events, including at least one of event type, occurrence time, duration, confidence score, and associated audio segment.

The term “bone-conduction actuator” refers to a transducer element that converts electrical signals into mechanical vibrations delivered through a portion of the user's body, such as the skull, to stimulate the inner ear without occluding the ear canal.

The term “satellite positioning information” refers to position-related data derived from signals of a satellite-based navigation system, including at least one of latitude, longitude, altitude, and associated accuracy metrics.

The term “wireless communication information” refers to data obtained from wireless communication systems, including at least one of identifiers and signal strengths of base stations or access points, used to assist in estimating the position of the user.

The term “position information” refers to data expressing an estimated physical location of the user, including coordinates and optionally a corresponding area label within an indoor or outdoor map.

The term “area information” refers to map-related data that associates spatial regions with semantic labels such as room identifiers, corridors, stairways, exits, or outdoor zones.

The term “movement state of the user” refers to a time-varying aspect of the user's location, including at least one of movement speed, direction, and pattern of movement.

The term “schedule information of the user” refers to time-based data indicating planned activities or appointments of the user, including events such as medication times, visits, or exercise sessions.

The term “health information of the user” refers to medical or wellness-related data associated with the user, including at least one of mobility limitations, medication plans, chronic conditions, and risk indicators such as fall risk.

The term “situation of the user” refers to a contextual state derived by combining position information, acoustic event information, schedule information, health information, and optionally historical data, to characterize the user's current circumstances.

The term “instruction information” refers to machine-generated guidance content that describes actions the user should perform, such as moving to a specific area or following a safety procedure.

The term “alert information” refers to machine-generated notification content that warns the user about potential or current risks, such as environmental hazards or high-risk areas.

The term “life-support information” refers to machine-generated assistance content aimed at supporting daily living activities of the user, including reminders, supportive tips, and contextual information for comfort and convenience.

The term “context data” refers to structured data that aggregates information about the user's situation, including at least one of position information, acoustic event information, schedule information, health information, and historical behavior information.

The term “prompt sentence” refers to a natural-language text sequence constructed by the processor that encodes context data and specifies generation requirements as input to a generative AI model.

The term “generative AI model” refers to a trained machine-learning model that receives a prompt sentence and generates natural-language text output, such as a guidance text, based on learned patterns.

The term “guidance text” refers to natural-language text output generated by the generative AI model that provides instructions, alerts, or supportive explanations tailored to the user's situation.

The term “text-to-speech processing” refers to processing that converts the guidance text into an audio signal suitable for playback, using a speech synthesis algorithm.

The term “terminal device” refers to a user-side computing device equipped with at least an acoustic sensor, a bone-conduction actuator, a communication interface, and optionally location and motion sensors, configured to communicate with the server.

The term “server” refers to a computing apparatus including at least one processor and memory, configured to perform centralized processing such as audio analysis, context aggregation, prompt construction, interaction with the generative AI model, and distribution of guidance to the terminal device.

The term “machine-readable context data” refers to data structures stored in memory that encode the user's current and recent context in a form suitable for algorithmic processing and prompt construction by the processor.

The term “history information” refers to stored records including at least one of movement history, behavior history, notification history, and assistance history of the user, used for adaptive control and personalization.

The term “adaptive control processing” refers to processing in which the processor dynamically adjusts at least one of prompt sentence content, guidance text length, expression difficulty, and output timing based on history information and current context.

In one embodiment, a system includes a server and a terminal that cooperate to provide context-aware guidance to a user via bone-conduction audio output. The terminal is physically worn or carried by the user and includes at least an acoustic sensor, a bone-conduction actuator, a communication interface, and optionally location and motion sensors. The server includes at least one processor and memory and executes software modules for audio analysis, multimodal context aggregation, prompt sentence construction, interaction with a generative AI model, and guidance delivery.

The terminal uses a hardware acoustic sensor implemented, for example, by a directional MEMS microphone array mounted near the user's head. The terminal controls the directivity pattern of the microphone array by changing phase and gain parameters in a beamforming module executed on an embedded processor, such as an ARM-based microcontroller or a low-power system-on-chip. The terminal further uses inertial sensors, such as a three-axis accelerometer and gyro, to obtain the motion state of the user. The terminal calculates the orientation of the user's head from the inertial data and adjusts the beamforming parameters so that the main lobe of the directivity pattern is aligned with a forward direction of the head.

This physical control of microphone directivity enables the terminal to suppress sound from irrelevant directions and to concentrate input data bandwidth on high-value acoustic signals.

The server receives acoustic data from the terminal as a sequence of digital frames. The server executes a noise suppression module implemented, for example, using a deep neural network with a convolutional encoder-decoder architecture. The server converts each audio frame into a time-frequency representation using a short-time Fourier transform with a fixed window size and overlap. The server feeds the resulting magnitude spectrogram into the neural network, which has multiple convolutional layers with rectified linear activation functions, a bottleneck layer, and corresponding deconvolutional layers. The server computes, for each time-frequency bin, an estimated suppression mask whose values indicate how much energy should be preserved or attenuated. The server multiplies the original magnitude spectrogram by the suppression mask and reconstructs a time-domain signal via inverse Fourier transform.

By learning the suppression mask from noisy and clean training data pairs during an offline training phase, the neural network reduces background noise while preserving speech, thereby increasing the signal-to-noise ratio for subsequent detection and recognition.

The server further executes an acoustic event detection module that receives the enhanced spectrogram as input. The server uses a recurrent or convolutional-recurrent neural network that processes sequences of spectral feature vectors. The server extracts mel-frequency cepstral coefficients or log-mel-spectrogram features and feeds them into the event detection network. The network outputs a probability for each predefined acoustic event class, such as an alarm tone, a staff call phrase, or a help-requesting shout. The server thresholds these probabilities and generates structured acoustic event information, including an event identifier, a start time, an end time, and a confidence score. Because the network is trained with a large set of labeled audio events, the server can robustly detect events in highly noisy environments where conventional threshold-based detectors fail.

The server also executes a speaker identification module. The server derives speaker embeddings from the enhanced audio using a neural network trained to produce fixed-length feature vectors for different speakers. The server compares the generated embedding with registered embeddings for the user and for staff accounts stored in a relational database. The server computes similarity scores, for example using cosine similarity, and identifies whether the segment is spoken by the user, a staff member, or an unknown person. This identification enables the server to adjust guidance logic; for instance, the server can treat a staff command differently from background dialogue.

The server then executes a speech recognition module. The server uses a neural network based automatic speech recognition engine, which may include an encoder-decoder architecture with attention or a transducer model, to convert speech segments into text. The server produces a time-aligned transcription and marks words that match predefined keywords, such as “help”, “emergency”, or the user's name. The server stores these transcriptions and keyword markers as part of the context data in memory.

The terminal is configured to collect position-related data. The terminal uses a satellite positioning receiver to obtain approximate latitude and longitude, and uses a wireless communication interface to collect identifiers and signal strengths of nearby access points or base stations. The terminal periodically sends these raw measurements to the server. The server executes a position estimation module that applies a probabilistic filter, such as an extended Kalman filter or a particle filter, to fuse the satellite positioning measurements with wireless signal observations and motion estimates derived from inertial sensor data. The server outputs position information in the form of coordinates with an associated uncertainty measure and also maps each coordinate point onto an indoor or outdoor area label using a map database. For example, the server labels positions as “corridor near east exit”, “dining room”, or “stairs area”. This multi-sensor fusion reduces location error and compensates for satellite signal degradation in indoor environments.

The server maintains a context data structure in memory. The server stores, for each time interval, fields such as current position label, movement speed, acoustic event list, recognized speech text, speaker identity, upcoming schedule entries, and health status indicators. The server updates this context data in real time and maintains a short-term history window. The server thus maintains a machine-readable representation of the user's situation that integrates heterogeneous inputs.

The server generates prompt sentences for a generative AI model based on this context data.

The server implements a prompt construction module that applies deterministic rules and templates. The server selects a template in accordance with a detected situation class, such as emergency guidance, fall-risk alert, medication reminder, or routine notification. The server then replaces placeholders in the template with the latest context values, including location, detected events, schedule entries, and user attributes such as mobility level or cognitive load tolerance. The server thereby constructs a concrete prompt sentence in natural language that encodes both the factual situation and constraints on the desired response, such as length limits and required politeness.

For example, when the user is detected near stairs and the acoustic event detection module has not detected any alarm, the server constructs a prompt sentence of the following form:

“You are an assistant in a nursing care facility.

The user is currently near the stairs on the second floor and walks slowly with a cane.

Generate a short, polite safety message in less than 25 words to warn the user to hold the handrail and not rush.”

In another example, when a medication event is approaching in the schedule information, the server constructs a prompt sentence of the following form:

“You are a gentle assistant for an elderly user.

It is now five minutes before the user's blood pressure medication time.

Create a calm, polite reminder in less than 20 words to take the medication with water.”

The server transmits the prompt sentence and optional control parameters, such as maximum number of tokens and temperature value, to a generative AI model. The generative AI model may be implemented as a large-scale language model with a transformer architecture that has been trained on a corpus including conversational and instructional text. The server receives the generated guidance text from the generative AI model as a sequence of tokens. The server applies post-processing rules to check that the output obeys constraints specified in the prompt sentence, such as length, tone, and absence of unsafe or ambiguous instructions. If necessary, the server truncates or rejects outputs that fail to meet these criteria, thereby exercising deterministic control over the model output.

The server sends the final guidance text to a text-to-speech engine. The text-to-speech engine may run on the server or on a separate computing resource and can be implemented using a neural vocoder architecture, such as a sequence-to-sequence model with an attention mechanism combined with a waveform generation model. The server specifies parameters such as speaking rate and pitch that are adapted to the user's hearing profile and cognitive state. The server obtains synthesized audio data and encodes the data in a compressed format for efficient network transmission. The server then sends the encoded audio to the terminal via a secure communication channel.

The terminal receives the encoded guidance audio, decodes it into a pulse code modulated stream, and drives the bone-conduction actuator using a class-D amplifier. The terminal applies automatic gain control that compensates for ambient noise levels measured at the acoustic sensor and for the user's stored hearing profile. The bone-conduction actuator generates mechanical vibrations that are transmitted through the skull to the inner ear, while leaving the ear canal open so that the user can still perceive ambient sound. This hardware control path directly couples the server's computed guidance to an electromechanical device, thereby creating a physical effect beyond mere information display.

The server records each delivered guidance message together with accompanying context data, such as location, detected events, and user responses. The server interprets user responses using the same audio analysis pipeline if the user replies verbally with phrases such as “OK”, “Repeat”, or “Help”. The server uses this history information to perform adaptive control processing. For example, if the server observes that the user frequently does not respond to long messages, the server adjusts template parameters so that future guidance texts are shorter. If the server observes that certain prompt formulations lead to misinterpretations, the server modifies the prompt templates to include more explicit constraints. This feedback mechanism improves the performance of the computing system over time by directly linking behavior of the generative AI model and user reactions to adjustments in prompt construction and scheduling logic.

The described architecture improves computer technology in several ways. The server reduces processing load by integrating multi-stage filtering and classification. The server uses voice activity detection, noise suppression, and event detection to avoid sending and analyzing irrelevant frames. This reduces CPU usage and memory bandwidth compared to systems that continuously process full-band audio without prioritization. The server improves accuracy of decision-making by combining heterogeneous data sources into a structured context data model, thereby reducing false positives and false negatives in guidance triggering. For example, the server can suppress an evacuation instruction if an alarm sound is detected but the position information indicates that the user is in a test area marked as non-critical.

The server also improves data management and communication efficiency. The server represents context data in compact, structured records and transmits only necessary fields to the generative AI model in the form of prompt sentences, rather than raw sensor streams. This design reduces network traffic and isolates the generative AI model from low-level noise.

Furthermore, by explicitly embedding structured context into prompt sentences, the server enables reproducible behavior and easier verification of outputs compared to ad-hoc natural language queries.

The server and terminal operate according to internal rules and learned models that differ from conventional human workflows. Unlike a human caregiver who might listen continuously and decide subjectively when to speak, the server uses quantitative thresholds on probability scores, error functions minimized during training, and explicit timing logic to control guidance. The neural networks for noise suppression, event detection, speaker identification, and speech recognition are trained offline using large data sets and optimization algorithms such as stochastic gradient descent with backpropagation. During training, the server or an associated training system defines a loss function appropriate for each task, such as mean squared error for spectral masking, cross-entropy for classification tasks, and sequence-to-sequence loss for speech recognition. The server updates model weights iteratively using mini-batches of training data, and may employ regularization and data augmentation techniques such as adding synthetic noise, time-stretching, or pitch-shifting to improve robustness. After deployment, the server uses the trained fixed-weight models exclusively for inference, thereby achieving stable inference latency and predictable resource usage.

Alternative embodiments are possible. In one variation, the terminal performs a larger share of processing, including local noise suppression and keyword spotting, to further reduce uplink bandwidth usage and server load. In another variation, the position estimation module uses different fusion algorithms, such as a deep neural network that takes raw satellite and wireless features as inputs and directly outputs a coordinate and area label. In yet another variation, the generative AI model is executed on the terminal under a compressed model configuration, while the server handles heavy audio analysis and context management.

The system can be implemented on diverse hardware and software stacks. The server may run on generic server hardware under a standard operating system and use a neural network framework to implement the described models. The terminal may use a real-time operating system on an embedded processor and implement beamforming, automatic gain control, and actuator control using digital signal processing libraries. Regardless of implementation details, the central technical features are the coordinated use of (i) dynamic directional acoustic capture controlled by user motion, (ii) multi-stage AI-based audio and location analysis, (iii) deterministic prompt sentence construction informed by structured context data, and (iv) controlled interaction with a generative AI model to create personalized guidance that is physically delivered to the user via bone conduction. Through these features, the system not only automates human tasks but also enhances computational efficiency, accuracy, and hardware control capabilities beyond conventional rule-based systems.

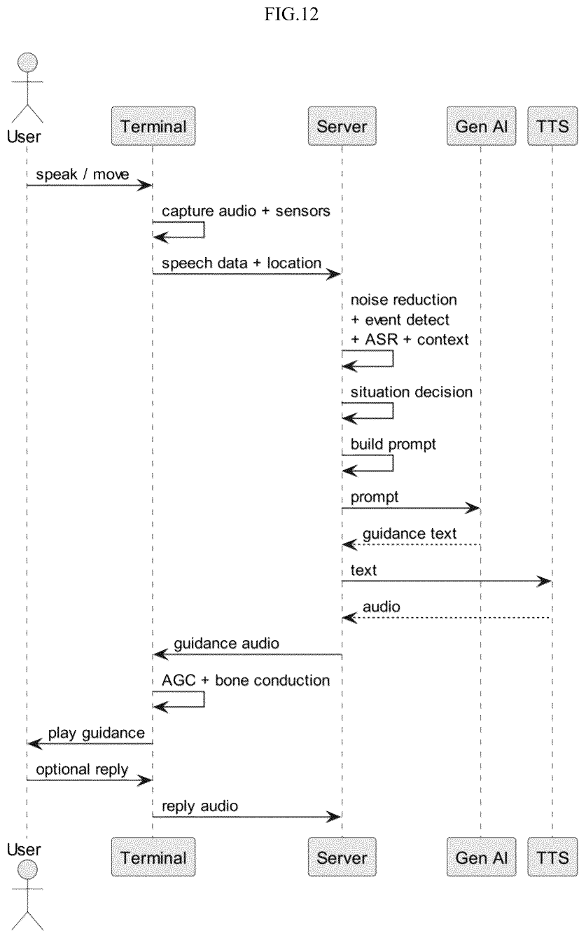

The following describes the processing flow using FIG. 12.

### Step 1

The terminal acquires raw sensor data as input, including analog acoustic signals from at least one directional microphone, inertial sensor readings from an accelerometer and gyroscope, and optional ambient noise level measurements.

The terminal converts the analog acoustic signal into digital PCM frames by sampling at a predetermined sampling rate and quantization bit depth, and timestamps each frame. The terminal calculates orientation and motion state of the user from the inertial sensor readings by integrating angular velocity and acceleration and applying sensor fusion algorithms. Based on the calculated orientation, the terminal adjusts beamforming coefficients or microphone gain parameters so that the main directivity lobe is aligned with a forward direction of the user's head. As output, the terminal produces directionally enhanced PCM audio frames and an updated motion state descriptor.

### Step 2

The terminal receives as input the directionally enhanced PCM audio frames and the motion state descriptor from Step 1.

The terminal computes frame-level energy and simple spectral features, such as zero-crossing rate and short-time Fourier transform magnitudes, to perform voice activity detection. Using threshold rules and optionally a lightweight classifier, the terminal classifies each frame as speech or non-speech. Frames classified as non-speech are discarded, while frames classified as speech are grouped into segments with associated timestamps and user ID. As output, the terminal generates compressed packets containing speech candidate segments and device status metadata for transmission to the server.

### Step 3

The terminal receives as input raw position-related signals, including satellite positioning measurements and wireless signal observations such as identifiers and signal strengths of access points or base stations.

The terminal aggregates these measurements over a predetermined time window and formats them into a structured location packet with timestamps and user ID. The terminal may also include derived motion estimates, such as step count or coarse speed, computed from inertial data. As output, the terminal transmits the location packet to the server over a secure communication channel.

### Step 4

The server receives as input the speech candidate audio packets from Step 2.

The server performs noise suppression by first converting each PCM frame into a time-frequency representation using a short-time Fourier transform, resulting in a complex spectrogram. The server feeds the magnitude spectrogram into a trained neural network that outputs a suppression mask, then multiplies the magnitude spectrogram by the mask to attenuate noise components. The server reconstructs an enhanced time-domain signal via inverse Fourier transform and overlap-add. As output, the server obtains enhanced audio segments with reduced background noise, along with associated metadata such as timestamps and user ID.

### Step 5

The server receives as input the enhanced audio segments from Step 4.

The server extracts spectral feature sequences, such as log-mel-spectrograms or mel-frequency cepstral coefficients, and feeds them into an acoustic event detection model and a speaker identification model. For acoustic event detection, the server computes class probabilities for predefined event types and applies a confidence threshold to decide whether events such as alarms, staff calls, or help-requesting utterances are present. For speaker identification, the server computes a speaker embedding for each segment and compares it to stored reference embeddings to classify the speaker as the user, staff, or unknown. As output, the server produces acoustic event information records and speaker identity tags associated with each audio segment.

### Step 6

The server receives as input the enhanced audio segments and, optionally, the speaker identity tags from Step 5.

The server applies a speech recognition engine to the enhanced segments. The server converts the audio into feature vectors and feeds them into an encoder-decoder or transducer-type neural network that outputs a sequence of textual tokens. The server then decodes these tokens into recognized text and searches for predefined keywords, such as “help”, “emergency”, or the user's name, using string comparison or pattern matching. As output, the server generates recognized speech text with time alignment information and keyword markers.

### Step 7

The server receives as input the location packet from Step 3.

The server applies a position estimation algorithm, such as an extended Kalman filter, which uses satellite coordinates as state measurements and wireless signal strengths as auxiliary observations. The server updates the internal state vector representing user position and movement velocity by computing prediction and correction steps of the filter. The server then maps the resulting coordinates onto an area label using a digital map database, for example labeling the position as “dining room” or “stairs area”. As output, the server produces position information consisting of coordinates, uncertainty metrics, movement state, and an area label.

### Step 8

The server receives as input the acoustic event information and speaker identity tags from Step 5, the recognized text and keyword markers from Step 6, and the position information from Step 7, as well as schedule and health records already stored in a database.

The server updates a context data structure by inserting current values for fields including area label, movement speed, detected event types, speaker identity, keyword occurrences, upcoming appointments, and relevant health flags such as fall risk or medication schedule.

The server may aggregate values over a short history window by computing recent counts or trends. As output, the server maintains a coherent, time-indexed context record representing the current situation of the user.

### Step 9

The server receives as input the context record from Step 8.

The server runs a situation classification logic that evaluates rule sets and possibly a learned classifier. The server checks if any emergency condition is met, such as detection of an alarm event with high confidence and presence of the user in a hazardous area, or detection of a help-requesting keyword. The server also checks for non-emergency conditions, such as an upcoming medication time, entry into a high fall-risk area, or approach of an appointment.

The server combines binary rule evaluations and classifier outputs to determine a situation label, such as “evacuation_needed”, “fall_risk_alert”, “medication_reminder”, or “no_action”.

As output, the server produces a situation label and associated parameters that specify message urgency and target action type.

### Step 10

The server receives as input the situation label and associated parameters from Step 9 together with the detailed context record from Step 8.

The server selects a prompt template based on the situation label, where each template contains fixed text segments and placeholders for context values and constraints. The server then fills in placeholders with actual values from the context record, such as current time, area label, user mobility description, and specific event descriptions. The server also inserts explicit instructions about desired output characteristics, such as “less than 25 words”, “polite tone”, or “do not mention internal system details”. As output, the server constructs a fully specified prompt sentence in natural language tailored to the current situation.

### Step 11

The server receives as input the constructed prompt sentence from Step 10.

The server sends the prompt sentence, along with generation parameters such as maximum token count, temperature, and top-k or top-p sampling settings, to a generative AI model via an application programming interface. The generative AI model processes the prompt sentence using a transformer-based architecture to produce a candidate guidance text. The server receives the candidate guidance text and evaluates it against predefined criteria, checking length, clarity, presence of required instructions, and absence of disallowed content.

If the guidance text does not meet the criteria, the server may adjust the prompt or parameters and resubmit, or apply truncation and filtering. As output, the server produces an approved guidance text that satisfies the specified constraints.

### Step 12

The server receives as input the approved guidance text from Step 11.

The server forwards the guidance text to a text-to-speech engine, specifying synthesis parameters such as language, voice type, speaking rate, and volume profile. The text-to-speech engine converts the guidance text into an audio waveform, and the server encodes this waveform into a compressed audio format for transmission. The server then constructs a guidance audio packet with metadata indicating message type, priority, and expiration time. As output, the server transmits the guidance audio packet to the terminal over a secure communication channel.

### Step 13

The terminal receives as input the guidance audio packet from Step 12.

The terminal verifies the integrity and authenticity of the packet, decodes the compressed audio into a PCM stream, and retrieves metadata such as message priority. The terminal consults local rules to decide whether to interrupt current playback or queue the new message, based on the priority and recent playback history. As output, the terminal generates a playback command and an associated PCM audio stream for presentation.

### Step 14

The terminal receives as input the playback command and the PCM audio stream from Step 13.

The terminal applies automatic gain control by analyzing the PCM amplitude and comparing it to a target loudness derived from the user's stored hearing profile and current ambient noise level. The terminal then converts the PCM stream into analog signals using a digital-to-analog converter and drives the bone-conduction actuator via a power amplifier. The bone-conduction actuator produces mechanical vibrations that propagate through the user's skull to the inner ear, delivering the guidance message without blocking the ear canal. As output, the terminal provides a physically perceived audio message to the user.

### Step 15

The user receives as input the bone-conducted audio guidance from Step 14 and, optionally, environmental sounds through the open ear canal.

The user interprets the guidance and may respond by changing behavior, such as slowing down near stairs, moving toward an exit, or taking medication, or by speaking a verbal response such as “OK”, “Repeat”, or “Help”. The user's verbal response is captured again by the terminal's acoustic sensor, forming new acoustic input that enters the processing flow from Step 1, while behavioral changes may update motion and location inputs. As output, the user generates observable actions and/or speech signals that are re-ingested by the system for further processing and adaptation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information provision systems that operate on wearable terminals typically deliver notifications based only on objective context such as location or time, and are implemented as fixed rule sets or simple heuristics. In noisy environments such as crowded transportation facilities or commercial complexes, these systems suffer from multiple technical problems.

First, existing audio processing pipelines on resource-constrained terminals do not adaptively integrate noise reduction, speech recognition, and emotion estimation in a unified control loop. Audio front-ends may reduce background noise, but they do not systematically use downstream emotion estimation results to control the strength of noise suppression, the selection of important audio segments, or the timing and density of notifications. As a result, the signal processing chain on the terminal side is not optimized for the user's current cognitive load or emotional state, and the terminal unnecessarily consumes computation and communication resources by handling and transmitting low-value audio or context data.

Second, conventional client-server architectures for context-aware services treat the server-side information selection logic as static business rules or hand-crafted decision trees.

When user states, environments, or service content types change over time, engineers must manually modify rule sets and templates. This causes a rigid backend that cannot quickly adapt to complex patterns in user emotion, mobility, and content relevance. In particular, server-side logic typically does not leverage a generative AI model through prompt sentences to automatically redesign or refine information selection rules, notification templates, or priority parameters. Thus, the information provision pipeline remains coarse-grained and cannot continuously improve based on the vast state information collected from terminals.

Third, known systems that provide audio notifications via bone conduction generally focus on the hardware channel for audio delivery, without tightly integrating: (i) terminal-side extraction of high-importance audio information under noisy conditions, (ii) terminal-side estimation of emotion from audio features and speech recognition results, and (iii) server-side adaptive optimization of information selection and notification methods using a generative AI model. Consequently, the entire computer system-including signal processing modules on the terminal and decision-making modules on the server-fails to achieve an efficient, low-latency, and personalized information pipeline. This leads to technical drawbacks such as unnecessary network traffic, excessive CPU/GPU utilization due to irrelevant notifications, and increased user distraction that can further degrade recognition accuracy and responsiveness of the system.

Therefore, there is a need for a computer-implemented system that technically improves the way in which terminal-side audio processing, emotion estimation, location acquisition, state transmission, server-side information selection, and generative AI-based rule optimization are orchestrated. Such a system should: (1) structure the data flow and control flow between terminal and server so that only high-value, context-aware information is generated and transmitted; (2) employ a generative AI model, driven by dynamically generated prompt sentences, to automatically adjust server-side rules and templates; and (3) optimize, in a closed loop, the end-to-end information provision pipeline, thereby improving computational efficiency, network efficiency, and robustness of human-machine interaction in noisy and complex environments.

The specific processing by the specific processing unit 290 of the data processing device 12 in Example 2 is realized by the following means.

The present invention provides a server comprising a processor configured to receive, via a communication network, state information transmitted from a terminal worn by a user, the state information including at least position information representing a current position of the user and emotion information representing an emotional state of the user that is estimated on the terminal based on audio feature quantities and a speech recognition result; to acquire, from an external information providing source, environment information or service information corresponding to the position information, including at least one of weather information, transportation information, and commercial facility information; to calculate, for each piece of the acquired environment information or service information, a presentation priority based on at least the position information, the emotion information, and user preference information, and to select user-oriented information to be presented to the user according to the presentation priority; to generate a prompt sentence in a natural language including at least the position information, the emotion information, and an information provision condition, and to input the prompt sentence into a generative AI model that outputs a response including at least one of a rule proposal and a template sentence relating to a notification frequency, a notification timing, an expression method of information content, and priority assignment for information categories; to set or update, based on the response from the generative AI model, an information selection rule, a notification method, a notification template, and a presentation-priority calculation parameter used for subsequent selection and formatting of the user-oriented information; and to provide the selected and formatted user-oriented information to the terminal as information for audio presentation via bone conduction. This enables a technical improvement of the overall computer system by allowing the server to automatically and dynamically optimize, in cooperation with the terminal, the information selection logic and notification behavior based on rich state information and generative AI responses, thereby reducing unnecessary data transmissions and processing, enhancing the relevance and timing of notifications under noisy conditions, and improving the efficiency, adaptability, and robustness of the information provision pipeline implemented by the processor.

The term “audio acquisition unit” refers to a hardware and software functional block configured to capture sound in an environment by using at least one acoustic sensor and to output an electrical or digital audio signal representing the captured sound.

The term “audio signal processing unit” refers to a functional block configured to perform digital signal processing on an audio signal, including at least windowing, frequency analysis, noise reduction, reconstruction of a time-domain signal, extraction of high-importance audio information, and generation of audio feature quantities and a speech recognition result.

The term “audio feature quantities” refers to numerical values derived from an audio signal, including at least time-series vectors such as cepstral coefficients, spectral envelope parameters, fundamental frequency, and energy, which are used as input to downstream machine learning models or recognition algorithms.

The term “speech recognition result” refers to text data or symbolic data generated by converting an audio signal into linguistic units, such as words or phrases, by means of an automatic speech recognition process executed by a software or hardware engine.

The term “emotion estimation unit” refers to a functional block configured to estimate an emotional state of a user by inputting audio feature quantities, a speech recognition result, or both into a machine learning model and to output emotion information representing the estimated emotional state.

The term “emotion information” refers to information representing an emotional state of a user, including at least an emotion label indicating a category of the emotional state and one or more numerical scores indicating probabilities or intensities associated with a plurality of emotion categories.

The term “position acquisition unit” refers to a functional block configured to obtain data from at least one positioning resource, including a satellite positioning system or a wireless communication network, and to output position information representing a geographic position or an indoor position associated with a user.

The term “position information” refers to data representing a current position of a user or a terminal, including at least one of geographic coordinates, floor identifiers, area identifiers, and associated time information.

The term “communication control unit” refers to a functional block configured to generate, transmit, receive, and parse messages via a communication network, including at least the generation and transmission of state information from a terminal to a server and the reception of information from the server at the terminal.

The term “state information” refers to data representing a current state of a user or a terminal, including at least position information, emotion information, and optionally user identification information and time information.

The term “bone-conduction output unit” refers to a hardware and software functional block configured to generate a vibration signal based on audio data and to drive a bone-conduction actuator so that the audio is transmitted to an inner ear of a user via vibration through a bone.

The term “vibration signal” refers to an electrical signal used to drive a mechanical transducer, the signal being configured to cause mechanical vibration at a frequency and amplitude corresponding to an audio waveform.

The term “generation information processing unit” refers to a server-side functional block configured to process state information received from a terminal, to acquire environment information or service information from an external information providing source, to calculate a presentation priority, to select information to be presented, to generate a prompt sentence, to invoke a generative AI model, and to update information selection rules and notification methods based on a response from the generative AI model.

The term “environment information” refers to information representing a state of an external environment related to a user, including at least one of meteorological conditions, transport operation status, congestion status, and safety alerts.

The term “service information” refers to information relating to one or more services available to a user at or near a current position, including at least commercial facility information, event information, promotional information, and guidance information.

The term “external information providing source” refers to an information system or data storage apparatus, accessible via a communication network, that is configured to provide environment information or service information through an interface such as an application programming interface.

The term “presentation priority” refers to a numerical or ordinal value calculated for each piece of candidate information, the value being used to determine an order, frequency, or probability with which the information is presented to a user.

The term “information selection rule” refers to a set of logical conditions, thresholds, or parameters that specify how candidate items of environment information or service information are filtered, ranked, or chosen for presentation to a user.

The term “notification method” refers to a set of parameters or procedures defining how selected information is presented to a user, including at least notification frequency, timing, modality, and phrasing or formatting of message content.

The term “information providing unit” refers to a server-side functional block configured to format and transmit user-oriented information to a terminal in accordance with information selection rules, notification methods, and presentation-priority calculation parameters.

The term “generative AI model” refers to a parameterized statistical machine learning model configured to receive a text input and to generate a text output in a natural language, the model being capable of producing rule proposals, template sentences, or other structured guidance for information selection or notification.

The term “prompt sentence” refers to a natural language instruction sentence or question sentence generated to be input into a generative AI model and including at least position information, emotion information, or an information provision condition.

The term “information provision condition” refers to data specifying constraints or preferences for information delivery, including at least desired notification frequency, acceptable delay, content categories of interest, and user experience requirements.

The term “notification template” refers to a text pattern or structure defining how selected information is expressed in natural language for presentation to a user, the pattern including fixed portions and variable portions corresponding to content parameters.

The term “presentation-priority calculation parameter” refers to a parameter used by a calculation algorithm in order to determine presentation priority values based on inputs such as position information, emotion information, user preferences, and attributes of candidate information.

The term “user-oriented information” refers to information that has been selected, formatted, and prioritized for presentation to a specific user based on state information, information selection rules, and notification methods.

The term “terminal” refers to a wearable or portable information processing apparatus configured to be worn or carried by a user, the apparatus including at least an audio acquisition unit, an audio signal processing unit, an emotion estimation unit, a position acquisition unit, a communication control unit, and a bone-conduction output unit.

The term “server” refers to one or more information processing apparatuses connected to a communication network, the apparatuses being configured to receive state information from terminals, access external information providing sources, invoke a generative AI model, and provide user-oriented information back to the terminals.

The term “machine learning model” refers to a computational model having trainable parameters and configured to output an estimated value or classification result, such as an emotional state, based on input data including at least audio feature quantities and a speech recognition result.

The term “neural network model” refers to a machine learning model composed of multiple layers of interconnected computational units, configured to process input data and to output scores corresponding to a plurality of categories, such as emotion categories.

In the following embodiments, a terminal, a server, and a user cooperate to implement the claimed system. The embodiments are illustrative and do not limit the scope of the invention.

### A. Overall Hardware and Software Configuration

A terminal is configured as a wearable information processing apparatus attachable near an ear or on a head of a user. The terminal includes at least: a microphone unit, an analog-to-digital conversion (ADC) circuit, a processor, a memory, a bone-conduction actuator, a wireless communication module, a positioning sensor subsystem, and a power supply.

The terminal uses, as the processor, a system-on-chip (SoC) that combines a general-purpose central processing unit (CPU), a digital signal processor (DSP), and optionally a neural-network accelerator. The terminal uses, as examples, an SoC of a type generally used in smartphones or wearable devices, such as a mobile application processor including an ARM-based CPU core, a DSP core, and an embedded graphics processing unit (GPU). The terminal runs an operating system such as a mobile operating system or a real-time operating system. The terminal stores, in a non-volatile memory, program code implementing audio signal processing, emotion estimation, communication control, position acquisition, and bone-conduction output control.

A server is configured as one or more information processing apparatuses including at least a CPU, a GPU or other accelerator, a main memory, a non-volatile storage device, and a network interface. The server runs a server-side operating system and a middleware stack including a web server, an application server framework, and libraries for machine learning inference and database access. The server stores, in a database, user-state records, environment and service information, configuration parameters, and logs.

An external information providing source is implemented as one or more networked information systems that expose application programming interfaces (APIs) for weather data, transportation data, and commercial facility data. The external information providing source returns structured data, for example in a text-based format, in response to API requests from the server.

A generative AI model is deployed on the server side or on a separate inference service accessible via a network. The generative AI model is implemented as a large-scale neural network, such as a Transformer-based language model, that accepts a prompt sentence in natural language and outputs a natural-language response. The generative AI model is accessed through an API client in the server application code.

### B. Terminal-Side Functional Configuration

### 1. Audio Acquisition and Front-End Signal Processing

The terminal uses the microphone unit and the ADC circuit as an audio acquisition unit. The microphone unit includes at least one miniature acoustic sensor, such as a microelectromechanical systems (MEMS) microphone, that converts sound pressure in the environment into an analog voltage signal. The ADC circuit samples the analog voltage at a fixed sampling frequency (for example, 16 kHz or 48 kHz) and quantizes the signal at a fixed bit depth (for example, 16 bits). The ADC driver in the operating system passes blocks of digital audio samples to an audio signal processing unit implemented by software running on the processor.

The terminal uses a DSP library, for example a fast Fourier transform (FFT) library, to perform short-time Fourier transform (STFT) on frame-segmented audio. The terminal applies a window function to overlapping frames, computes frequency spectra, estimates noise power in each frequency bin based on a noise model (for example, a long-term minimum statistics estimator), and attenuates noise components using spectral subtraction or a learned time-frequency mask.

In one embodiment, the terminal uses a compact neural network model, such as a convolutional recurrent neural network (CRNN), executed by a neural-network inference engine on the DSP or NPU, to predict, for each time-frequency bin, a mask value between 0 and 1 that indicates how strongly the bin should be preserved as speech. The terminal multiplies the complex spectrum by the mask and then reconstructs a denoised waveform via inverse FFT and overlap-add. By executing this processing on the local processor and accelerator, the terminal reduces background noise before any further feature extraction or transmission, which improves recognition accuracy and reduces overall data volume.

The terminal extracts audio feature quantities from the denoised waveform. The terminal computes at least Mel-frequency cepstral coefficients (MFCCs), frame energy, spectral centroid, and pitch (fundamental frequency) for each frame. The terminal arranges these features into a time-series matrix where each row corresponds to a frame and each column corresponds to a feature dimension. The terminal stores the feature sequence in memory and passes the sequence to both an emotion estimation unit and a speech recognition engine.

### 2. Speech Recognition and Keyword Extraction

The terminal performs speech recognition on the denoised audio or directly on the feature sequence. The terminal uses a speech recognition engine implemented by software, for example an engine that combines an acoustic model, a pronunciation lexicon, and a language model. The acoustic model is a neural network, such as a bidirectional long short-term memory (BiLSTM) or Transformer acoustic model, that converts feature sequences into phonetic or subword probabilities. The decoder uses beam search with a language model to generate a most likely text sequence.

The terminal then applies keyword extraction logic. The terminal stores, in memory, a list of important words or patterns such as “delay”, “platform change”, “time sale”, “meeting”, and registered project names. The terminal scans the recognized text using pattern matching (for example, simple string search or regular expressions) to identify occurrences of such keywords. The terminal marks frames or time ranges where the important words occur and treats the corresponding audio as high-importance audio information.

By executing keyword extraction on the terminal, the terminal can locally decide which parts of audio are relevant and need to be considered in later processing, reducing the need to transmit entire transcripts or continuous raw audio to the server.

### 3. Emotion Estimation

The terminal uses the emotion estimation unit to infer an emotional state of the user from audio feature quantities and the speech recognition result. The terminal implements the emotion estimation unit as a neural network model that receives, as input, a time-series tensor of features and optionally text-derived features (for example, an embedding of recognized words). In one embodiment, the model includes:
an input layer receiving a sequence of feature vectors,
one or more recurrent layers such as gated recurrent unit (GRU) or LSTM layers that aggregate temporal context,
optional attention mechanisms that emphasize frames with strong emotional cues,
a fully connected output layer that outputs scores for emotion categories such as “neutral”, “stressed”, “nervous”, and “relaxed”.

The terminal computes, for each category, a score via a softmax function so that the scores represent probabilities. The terminal takes, as an emotion label, the category with the highest score, and keeps the full vector of scores as detailed emotion information. The terminal may also derive a continuous stress index by a weighted sum of category scores.

The terminal executes the emotion estimation model on the local processor or on a dedicated neural-network accelerator using an inference library, for example a lightweight neural-network runtime for embedded devices. The model parameters have been pre-trained on an offline dataset containing audio recordings and ground-truth emotion labels. During training, the server used backpropagation, a cross-entropy loss function, and stochastic gradient descent or an adaptive optimizer (for example, Adam). The server optionally performed data augmentation, such as noise addition or pitch shifting, to increase robustness.

As a result, the deployed model can reliably estimate emotional states even under various noise conditions.

By running the emotion estimation on the terminal, the system avoids sending raw or detailed audio to the server for emotion analysis, thus reducing network load and latency and improving privacy. Additionally, the emotion information becomes available locally to control notification behavior and bone-conduction output parameters.

### 4. Position Acquisition and State Information Generation

The terminal uses the position acquisition unit to determine a current position of the user. The position acquisition unit obtains signals from a satellite positioning resource (for example, a GNSS receiver) and from a wireless communication module that detects base stations or access points. The terminal combines satellite-based coordinates and indoor positioning data (such as access-point identifiers and signal strengths) using a positioning algorithm, for example weighted trilateration or fingerprint matching, to determine latitude/longitude or indoor zone identifiers.

The terminal assembles state information that includes at least: position information, emotion information, and optionally user identification and time information. The terminal formats the state information as a structured record with fields, such as:
user_id,
timestamp,
position (coordinates or area ID),
emotion_label,
emotion_scores (vector),
optional additional context (for example, high-importance keyword flags).

The terminal uses the communication control unit to send the state information to the server over a wireless network using a secure transport protocol.

### 5. Bone-Conduction Output Control

The terminal uses a bone-conduction output unit to present audio to the user. The terminal receives user-oriented information from the server and combines it with locally extracted high-importance audio information. The terminal converts textual contents into audio waveforms using a text-to-speech engine running on the processor. The terminal applies volume normalization and dynamic-range control, referencing the emotion information so that, for example, volume and speaking rate are reduced when the user appears stressed.

The terminal then converts the digital audio waveform into an analog vibration signal via a digital-to-analog converter (DAC) and a driver amplifier. The bone-conduction actuator transforms the analog signal into mechanical vibrations transmitted through a bone near the ear to the inner ear. Because the ear canal remains open, ambient sounds can still be perceived.

The terminal can adjust the output timing, ordering, and repetition of messages based on the emotion information and user settings stored in memory. For example, when the stress index exceeds a threshold, the terminal may suppress low-priority commercial messages and only output safety-related or time-critical notifications.

### C. Server-Side Functional Configuration

### 1. Reception and Storage of State Information

The server uses the generation information processing unit and the information providing unit as software modules executing on the CPU. The server receives state information from a plurality of terminals via a network interface and an application server framework. The server parses the received message and stores it in a database as a state record. The server maintains both a latest-state table and a historical table, indexing by user identifier and time.

By organizing state information in such structured tables, the server can efficiently query recent emotional states and positions for each user and can perform pattern analysis or logging for later optimization.

### 2. Acquisition of Environment and Service Information

The server acquires environment information and service information by invoking external information providing sources. The server calls APIs of weather, transportation, and commercial facility services with parameters including position information and time. The external services return, for example, current weather, warnings, train delays, platform changes, store promotions, and event schedules.

The server normalizes these responses into a unified internal data structure. For each information item, the server stores at least: a category (for example, weather, transport, commercial), a geographic scope, a temporal validity window, a severity or importance indicator if provided, and raw content text.

### 3. Calculation of Presentation Priority and Information Selection

The server calculates, for each candidate information item, a presentation priority value using a scoring function implemented as code executing on the CPU. The scoring function takes into account at least:
distance between the user's position and the location relevant to the information item,
remaining validity time of the information item,
emotion information (for example, penalizing low-priority items when stress is high),
user preference parameters stored in the database (for example, preferred categories or opt-out settings).

The server, for example, uses a weighted linear combination:

priority=w1×proximity_score+w2×urgency_score+w3×emotion factor+w4×preference_match,
where w1-w4 are tunable parameters, and each component is computed from the item attributes and the state information. The server may apply non-linear transforms or thresholding for certain categories, such that safety warnings always exceed a minimum priority.

The server then sorts candidate items by priority and selects a subset that exceeds a threshold or that fits within a maximum count. The server attaches to each selected item a preliminary notification template and parameters needed by the terminal for text-to-speech.

This structured scoring and selection algorithm differs from simple human-defined heuristics, because the weights and rules are themselves adjusted over time using responses from the generative AI model, as described below.

### 4. Use of Generative AI Model and Prompt Sentences

The server uses a generative AI model to refine information selection rules, notification templates, and presentation-priority calculation parameters. The server generates prompt sentences in natural language that encode system state and desired optimization scenarios.

The server composes a prompt sentence that includes, for example:
descriptions of typical user positions and emotional states,
current rule settings (for example, current weight values and notification frequencies),
goals such as reducing cognitive load or emphasizing safety information.

Examples of such prompt sentences include:

“Based on the user's location information and emotional state (high stress) during the morning commute on a crowded station platform, propose concrete rules and example messages for delivering delay information and platform-change information via bone-conduction earphones, including suitable notification frequency, priority, and wording that minimize cognitive load.”

“Design notification rules for real-time delivery of discount and event information in a large commercial facility, using the user's indoor location and emotional state (relaxed or excited).

Explain appropriate notification timing, maximum frequency, and content selection criteria to maintain a pleasant user experience.”

“For a meeting-assistance system where the user is estimated to be confused, describe how to deliver explanations of technical terms and summaries of past minutes via bone-conduction earphones. Include required speech recognition, emotion recognition, and timing control strategies, and provide example notification messages.”

The server inputs these prompt sentences into the generative AI model via an API. The generative AI model, implemented as a Transformer with multiple attention layers and trained on large-scale text corpora, outputs responses containing:
candidate rule sets for prioritizing categories under different emotional states,
suggestions for notification frequency and timing thresholds,
alternative phrasings for notifications to reduce cognitive load,
criteria for when to suppress advertisements.

The server parses the response and maps textual suggestions into structured parameters. For example, if the response suggests “when stress is high, only safety and transportation alerts should be delivered and no more than one notification every 60 seconds,” the server adjusts:
category-based priority weights,
maximum notification rate parameters,
suppression flags for commercial categories under a given emotion.

The server stores updated parameters in a configuration store. Successive invocations of the generative AI model allow the system to iteratively refine rules as real-world usage data evolves, without manually redesigning algorithms.

From a technical perspective, the use of the generative AI model here is not merely to automate human decision-making, but to reconfigure underlying control parameters in the computer system at a granularity and complexity that would be difficult to achieve with static, hand-crafted rules. By doing so, the server can improve computational efficiency (for example, by eliminating selection and formatting of low-value items), reduce network traffic (by lowering the number of notifications under certain conditions), and improve overall robustness of the system.

### D. Technical Effects and Improvement of Computer Technology

The system achieves several technical improvements beyond simple automation of human decision processes.

First, the terminal performs multi-stage signal processing (noise reduction, feature extraction, emotion estimation, speech recognition, keyword extraction) under a coherent data flow.

Because the terminal uses emotion information to adjust local behavior (for example, suppressing certain categories of notifications when stress is high), the terminal can reduce CPU, DSP, and radio usage compared to systems that indiscriminately process and send all data. This improves energy efficiency and increases battery life of the terminal.

Second, the structured state information and scoring algorithm on the server enable efficient retrieval and ranking of relevant information. By encoding position, emotion, and preferences as fields in state records and by using tuned numerical parameters, the server reduces processing latency for each request and avoids unnecessary data deliveries.

Third, the dynamic optimization logic using the generative AI model improves the underlying computing architecture. Rather than directly presenting AI-generated text to the user, the server uses AI to design and adjust machine-readable rule sets and templates, which are then executed deterministically by conventional code. This separation allows consistent, reproducible behavior while leveraging the generative AI model's capacity to search a large space of rule configurations. As a result, the system can adapt to new patterns of user behavior or environmental conditions without redesigning program modules, improving maintainability and long-term performance.

Fourth, the tight integration of bone-conduction output with emotion-aware selection logic produces a closed feedback loop between the terminal and server. By correlating state information and behavioral outcomes (for example, whether users respond to certain notifications), the system can further refine templates and timing conditions. This continuous optimization improves accuracy of information delivery, reduces error in user understanding (for example, by focusing on clearly phrased essential alerts), and shortens the time required for the user to react appropriately.

### E. Variations and Alternative Embodiments

The terminal can implement the emotion estimation model using various architectures, such as a pure convolutional model, a Transformer-based sequence model, or a hybrid model with convolution, recurrent, and attention layers. The terminal can also include additional sensors, such as heart-rate sensors or accelerometers, and augment the emotion information with physiological or motion features.

The server can employ different learning strategies for tuning scoring functions. In one variant, the server uses reinforcement learning, defining a reward signal based on user engagement or complaint rates, and uses this reward to adjust weight parameters of the scoring function. The generative AI model can provide initial configurations or constraints for the reinforcement learning process.

The communication protocol between the terminal and server can be implemented using different transport layers, such as HTTP over TCP/IP, message queues, or persistent streaming protocols. The specific message format can be chosen among various structured text or binary encodings, as long as it conveys state information fields and selected information fields.

The bone-conduction output unit can use alternative actuator designs and driver circuits. For example, the terminal can include a multi-band equalization module to compensate for individual differences in skull transmission characteristics, using calibration data stored per user.

In all these embodiments, the common feature is that the terminal and server cooperate via defined data structures (state information, selected information, configuration parameters) and processing modules (audio signal processing, emotion estimation, scoring, generative AI-based optimization) to implement an information-provision pipeline that is technically optimized in terms of processing efficiency, robustness under noise, network load, and adaptability, rather than merely automating a human information-delivery workflow.

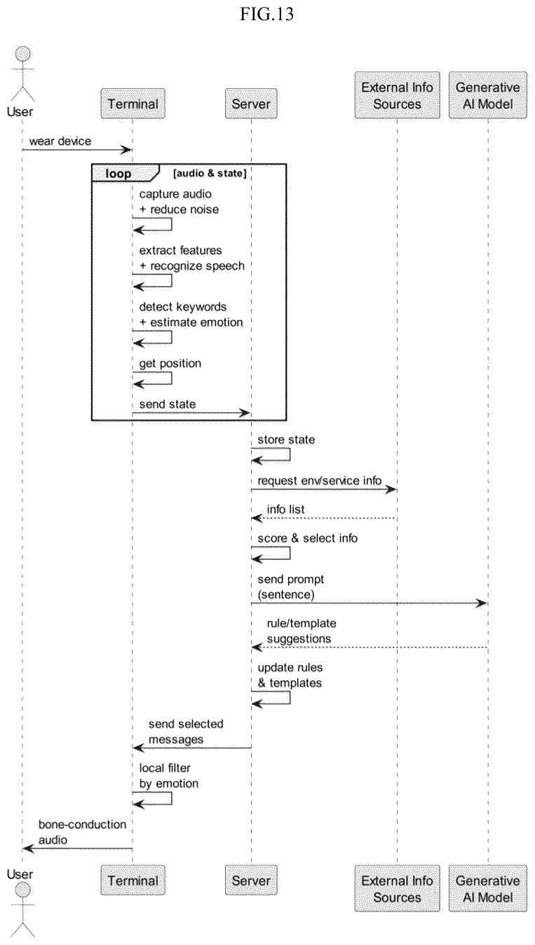

The following describes the processing flow using FIG. 13.

### Step 1

Terminal initializes audio acquisition and captures raw audio.

Terminal sets up a microphone driver and configures an analog-to-digital converter with a sampling rate and bit depth. Terminal's input is an analog sound pressure signal arriving at the microphone from the surrounding environment, including ambient noise and spoken announcements or conversations. Terminal converts the analog signal into a stream of digital audio samples and segments the stream into overlapping frames of a fixed length (for example, 25 ms with 10 ms shift). Terminal's output is a time-ordered sequence of digital audio frames stored in a buffer.

### Step 2

Terminal performs noise reduction on the digital audio frames.

Terminal's input is the sequence of framed digital audio samples from Step 1. Terminal applies a window function (for example, Hamming window) to each frame and computes a short-time Fourier transform on each frame to obtain a complex spectrum. Terminal estimates a noise power spectrum by averaging low-energy regions or using a minimum statistics algorithm, and then subtracts or attenuates the estimated noise power from the observed spectrum in each frequency bin. In an alternative embodiment, terminal applies a neural-network-based time-frequency mask predicted by a compact convolutional recurrent model to each spectrum. Terminal reconstructs a time-domain waveform for each frame via inverse FFT and overlap-add. Terminal's output is a sequence of noise-reduced audio frames.

### Step 3

Terminal extracts audio feature quantities from the noise-reduced audio.

Terminal's input is the noise-reduced frame sequence from Step 2. Terminal computes, for each frame, Mel-frequency cepstral coefficients, log-Mel filterbank energies, frame energy, spectral centroid, and fundamental frequency using a digital signal processing library.

Terminal concatenates these per-frame vectors into a two-dimensional array representing a time-series of features. Terminal's output is an audio feature sequence that is used as input to an emotion estimation model and to a speech recognition engine.

### Step 4

Terminal performs speech recognition and keyword extraction.

Terminal's input is the noise-reduced audio frames and optionally the feature sequence from Step 3. Terminal feeds the features into a speech recognition engine that includes an acoustic model and a language model. Terminal computes, frame by frame, a probability distribution over phonetic units using a neural acoustic model such as a recurrent or Transformer network, and then performs decoding with a beam search algorithm to obtain a most probable text sequence. Terminal then compares the recognized text against a stored keyword list using string matching and identifies occurrences of important terms such as “delay”, “platform change”, “time sale”, or project names. Terminal marks the time intervals where such keywords appear. Terminal's output is a recognized text string and a list of detected important keywords with associated time ranges.

### Step 5

Terminal estimates the emotional state of the user.

Terminal's input is the audio feature sequence from Step 3 and, optionally, the recognized text from Step 4. Terminal constructs an input tensor by grouping features over a fixed time window and encodes the text as an embedding vector if available. Terminal feeds this tensor into an emotion estimation neural network that includes at least one recurrent or attention-based layer. The network computes intermediate hidden states and then outputs a vector of scores for predefined emotion categories such as neutral, stressed, nervous, and relaxed. Terminal applies a softmax function to transform raw scores into probabilities and selects the category with the maximum probability as the emotion label. Terminal may compute a continuous stress index from the probability distribution. Terminal's output is emotion information including the emotion label, the per-category scores, and the stress index.

### Step 6

Terminal acquires current position information.

Terminal's input is raw positioning signals from a satellite positioning receiver and identifiers and signal strengths from nearby wireless access points or base stations. Terminal applies a positioning algorithm that converts satellite signal timing and wireless signal strength into an estimate of latitude and longitude, or into an indoor position such as a floor ID and area ID.

Terminal may fuse multiple sources by computing a weighted average or by selecting the most reliable source based on signal quality metrics. Terminal's output is position information that includes coordinates or area identifiers and a timestamp.

### Step 7

Terminal generates and transmits state information to the server.

Terminal's input is the emotion information from Step 5 and the position information from Step 6, along with a stored user identifier. Terminal creates a state record that combines user ID, timestamp, emotion label, emotion scores, stress index, and position data into a structured message. Terminal serializes the record into a text or binary representation and uses a communication protocol stack to transmit the record to the server over a wireless network.

Terminal's output is a state information packet that is delivered to the server.

### Step 8

Server receives and stores the state information.

Server's input is the state information packet from Step 7 received via a network interface.

Server parses the packet, checks integrity and authentication, and writes the state data into a database as a new record associated with the user. Server also updates a cache representing the latest state for each user by overwriting older entries. If historical analytics are enabled, server appends the record to a time-series table. Server's output is an updated state database and a current-state cache for use in subsequent selection and optimization processes.

### Step 9

Server acquires environment information and service information based on the state.

Server's input is the latest state for the user from Step 8, including position information, emotion information, and user preferences stored in the database. Server composes requests for external information providing sources by embedding the position, time, and relevant parameters into query strings or API request bodies. Server sends these requests to weather, transportation, and commercial information services and receives structured responses. Server normalizes the responses into internal records containing category, location, validity period, severity or importance, and content text. Server's output is a list of candidate environment and service information items associated with the user's current context.

### Step 10

Server calculates presentation priority and selects information for the user.

Server's input is the candidate information list from Step 9 and the user's state information from Step 8. Server computes, for each item, individual scores such as proximity score, urgency score, emotion-adjusted relevance score, and preference match score. Server then combines these scores using a predefined or learned mathematical formula, for example a weighted sum or a non-linear function, to produce a presentation priority value. Server sorts the items by priority and filters out items whose priority is below a threshold or whose validity has expired. Server selects a predetermined maximum number of top-priority items to be sent to the terminal. Server's output is a selected information list with priority values and associated content.

### Step 11

Server generates a prompt sentence and invokes the generative AI model to optimize rules.

Server's input is the current configuration of scoring weights and notification parameters, aggregated statistics from stored state information, and one or more representative usage scenarios. Server constructs a prompt sentence in natural language that describes the user's typical position patterns, emotional states, current notification rules, and desired optimization goals. For example, server may generate:

“Based on the user's location information and emotional state (high stress) during the morning commute on a crowded station platform, propose concrete rules and example messages for delivering delay information and platform-change information via bone-conduction earphones, including suitable notification frequency, priority, and wording that minimize cognitive load.”

Server sends this prompt sentence to the generative AI model through an API and receives a natural-language response that contains recommendations for rule changes, threshold adjustments, and message templates. Server parses the response to extract structured parameters and updates the internal configuration of scoring weights, category priorities, maximum notification rates, and default phrasing patterns. Server's output is an updated rule set and notification template set that will be applied in subsequent executions of Step 10 and Step 12.

### Step 12

Server formats selected information and transmits it to the terminal.

Server's input is the selected information list from Step 10 and the updated notification templates from Step 11. Server combines each selected information item with an appropriate template based on its category and urgency, fills in variable fields such as location, time, and specific values, and creates a concise text message suitable for audio presentation. Server packages these messages into a response message that includes identifiers, priorities, and optional display hints. Server then transmits the response message to the terminal via the network interface. Server's output is a formatted information packet containing user-oriented messages.

### Step 13

Terminal receives selected information and applies local filtering.

Terminal's input is the formatted information packet from Step 12 and the latest local emotion information from Step 5 and user settings stored in memory. Terminal examines each candidate message, compares its category and priority with local rules, and checks the user's current emotion state. When the stress index is high, terminal suppresses lower-priority or advertisement-type messages by discarding or deferring them. Terminal may also merge or shorten messages to limit total notification time. Terminal's output is a final notification list containing text messages and their delivery order to be presented via bone conduction.

### Step 14

Terminal converts the final notification list into bone-conducted audio.

Terminal's input is the final notification list from Step 13. Terminal invokes a text-to-speech engine to synthesize audio waveforms for each text message using a preconfigured voice model. Terminal then adjusts the amplitude and dynamic range of each waveform according to user hearing preferences and the current emotion state, for example lowering volume and speaking speed when the user is stressed. Terminal converts the digital waveform into an analog vibration signal through a digital-to-analog converter and drives a bone-conduction actuator with the signal. The actuator produces mechanical vibrations that propagate through bone to the inner ear. Terminal's output is a sequence of mechanical vibrations corresponding to the messages, perceived as audio by the user.

### Step 15

User perceives the bone-conducted audio and takes actions.

User's input is the bone-conducted audio output from Step 14 combined with ambient sounds perceived through the ear canal. User cognitively processes messages such as “The train on your usual line is delayed by 10 minutes; platform has changed to 3” or “A special discount is available at the nearby store for the next 20 minutes” and may change behavior accordingly, for example by selecting an alternative route, moving to a different platform, or visiting a suggested facility. User's movement and subsequent speech create new audio and position signals that are again captured by the terminal in Step 1 and Step 6, thereby closing the feedback loop of the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional assistive information systems for elderly or care-requiring users often rely on simple rule-based prompts or fixed audio messages that do not adapt to a user's nuanced emotional state, real-time context, or cognitive capabilities. From a computer technology standpoint, these systems typically process audio and sensor inputs in loosely coupled components, without an integrated architecture that jointly exploits acoustic features, linguistic content, biometric data, and location context to refine emotional inference and to dynamically control how guidance is generated and presented. As a result, computing resources at the terminal and server are not used optimally: terminal-side processing is often either too heavy, reducing battery life and responsiveness, or too shallow, forcing the server to repeatedly process raw data; server-side processing often treats multimodal inputs in isolation, leading to sub-optimal emotion recognition accuracy and delayed or inappropriate responses.

Moreover, traditional systems that provide voice guidance usually generate messages from a static library, or at most apply simple template filling, and therefore cannot flexibly adapt language, tone, and information density to match a changing emotional state or environmental risk. Even when generative AI models are used, they are typically invoked in a generic way, without a structured, machine-driven mechanism for constructing a prompt sentence that reliably encodes multimodal user context and system constraints. This leads to unpredictable outputs, additional manual curation, and difficulty in assuring safety and consistency in a resource-constrained, real-time care environment.

In addition, existing audio presentation pipelines generally lack a closed-loop control that ties the output parameters of text-to-speech synthesis (such as volume, speaking rate, pitch, and repetition) to the continuously estimated emotional and physiological state of the user. As a consequence, the computing system cannot automatically adapt its audio rendering strategy to minimize cognitive load and stress while maintaining intelligibility in noisy environments or critical situations. This results in inefficient use of audio processing and communication resources, potential over-notification, and an increased risk that important alerts are missed or misunderstood.

Accordingly, there is a need for a technically improved computer-implemented system in which: (i) terminal-side processors perform structured, lightweight pre-processing and provisional emotion estimation to reduce communication load and latency; (ii) server-side processors perform integrated, history-aware emotion recognition and risk assessment using multimodal state information; (iii) a processor-implemented mechanism automatically constructs context-rich prompt sentences for a generative AI model based on the refined emotional state, location context, and user attributes; and (iv) a processor-controlled audio presentation pipeline ties the generative AI output to adaptive speech synthesis and bone-conduction transmission parameters. Such an architecture would improve the overall efficiency, accuracy, and robustness of the computing system in delivering safe and psychologically appropriate guidance to users in care environments.

The specific processing by the specific processing unit 290 of the data processing device 12 in Application Example 2 is realized by the following means.

The present invention provides a server comprising at least one processor and at least one memory storing instructions that, when executed by the at least one processor, cause the server to receive, via a network interface, state information from a portable information processing device including audio-derived feature quantities, provisional emotional state information, location-related information, and biometric information, to store the state information in at least one database, to perform integrated emotion recognition by executing an emotion estimation model that combines the received state information with historical emotional state information, location history, and biometric history stored in the database to generate a refined emotional state and an updated stress index for a user, to construct a context-rich prompt sentence for a generative AI model by embedding the refined emotional state, the updated stress index, current location-related information, and user attribute information retrieved from the database into a template defining constraints on language, tone, and length, to transmit the prompt sentence to the generative AI model through a service interface and to receive, from the generative AI model, guidance text generated in response to the prompt sentence, to determine one or more audio presentation parameters including at least a speaking rate factor, a pitch factor, a volume factor, and a repetition count based on the refined emotional state and the updated stress index, to perform at least a consistency or length check on the guidance text, and to transmit, via the network interface, the guidance text together with the determined audio presentation parameters to the portable information processing device for text-to-speech synthesis and bone-conduction transmission. This enables a technically improved computer-implemented architecture in which terminal-side and server-side processing are functionally partitioned and coordinated to reduce communication overhead and latency, in which the server achieves higher-accuracy, history-aware emotional inference and risk assessment using multimodal data, in which the generative AI model is driven by systematically constructed prompt sentences that encode user context and system constraints, and in which adaptive audio rendering parameters are computed and applied in a closed loop, thereby improving the efficiency, reliability, and appropriateness of machine-generated guidance delivered to users in safety-critical care environments.

The term “audio collection unit” refers to a hardware and software component configured to capture sound, including at least one acoustic sensor such as a microphone, an analog-to-digital conversion circuit, and a control circuit or program that acquires audio signals representing sound around a user or utterances of the user.

The term “audio signal processing unit” refers to a hardware and software component configured to process digital audio signals, including performing at least frequency analysis, noise suppression, calculation of acoustic feature quantities such as spectral features and prosodic features, and detection of important sounds and speech sections.

The term “speech content acquisition unit” refers to a hardware and software component configured to perform automatic speech recognition on audio corresponding to detected speech sections to generate text data, and to extract keywords from the text data based on a predetermined vocabulary set.

The term “acoustic feature quantities” refers to numerical values calculated from audio signals that characterize sound properties in time or frequency domains, including at least spectral features, prosodic features such as pitch and energy, and optionally derived coefficients such as mel-frequency cepstral coefficients.

The term “important sounds” refers to particular classes of audio events that should be specially recognized or handled by the system, including at least emergency alarms, caregiver calls, system notification tones, and other predefined acoustic patterns that satisfy specified conditions.

The term “speech sections” refers to contiguous time intervals within an audio signal that have been determined by a voice activity detection process to contain speech, as opposed to silence or non-speech noise.

The term “biometric information” refers to measurement data indicating at least one physiological parameter of a user, including but not limited to heart rate, heart-rate variability, body temperature, blood pressure, respiratory rate, physical activity level, posture, and fall-detection results.

The term “emotion recognition unit” refers to a hardware and software component configured to execute an emotion estimation algorithm that takes as input acoustic feature quantities, speech content, extracted keywords, biometric information, and optionally historical data, and outputs an estimated emotional state and a stress index of a user.

The term “emotional state” refers to an estimated psychological condition of a user represented as a category such as normal, anxiety, confusion, agitation, anger, or reassurance, or as a continuous numerical value indicative of affective intensity.

The term “stress index” refers to a numerical indicator computed by the emotion recognition unit that quantifies a degree of stress or arousal of a user, derived from multimodal input including at least acoustic features and biometric information.

The term “location information acquisition unit” refers to a hardware and software component configured to acquire location-related information of a user or a terminal device, using at least one of a satellite positioning device and a wireless communication device, and to derive semantic location information within a facility or surrounding environment from such information.

The term “location-related information” refers to data indicating a position, movement, or area of a user or a device, including at least geographic coordinates, indoor area identifiers, movement speed, movement direction, and temporal information associated with such position or movement.

The term “semantic location information” refers to location information that has been converted from raw spatial coordinates or signal measurements into context-interpretable labels, such as corridor, user room, staircase area, entrance area, or specific floor and wing within a facility.

The term “motion information” refers to data derived from motion sensors, position changes, or other sources that indicate movement behavior of a user or device, including at least acceleration, angular velocity, step patterns, posture changes, and trajectory patterns.

The term “fall” refers to a movement event detected from motion information and location-related information in which a user undergoes a rapid change in acceleration or posture characteristic of losing balance and contacting a surface, followed by relative inactivity or other indicative patterns.

The term “wandering pattern” refers to a pattern of movement inferred from motion information and location history in which a user repeatedly moves back and forth or circles within a limited area, particularly in contexts or time periods that deviate from typical behavior.

The term “user attribute information” refers to information indicative of inherent or relatively stable characteristics of a user, including at least age, gender, cognitive level, hearing characteristics, health history, living habits, preferences, and care level.

The term “generative AI cooperation unit” refers to a hardware and software component configured to construct a prompt sentence based on current emotional state, location-related information, and user attribute information, to transmit the prompt sentence to a generative AI model through a communication interface, and to acquire guidance text generated by the generative AI model.

The term “prompt sentence” refers to text data provided as input to a generative AI model, which encodes instructions, constraints, and contextual information about a user or environment, and which conditions the generative AI model to generate guidance text satisfying specified content, style, and length.

The term “generative AI model” refers to a machine learning model, such as a large language model, that is configured to generate new text, responses, or guidance messages based on an input prompt sentence and internal learned parameters.

The term “guidance text” refers to text generated by a generative AI model in response to a prompt sentence, the text being intended for presentation to a user as guidance, instruction, notification, or reassurance.

The term “control unit” refers to a hardware and software component configured to determine one or more presentation parameters, including at least volume, speaking rate, pitch, and number of repetitions, for presenting guidance text, based on an estimated emotional state and a stress index of a user.

The term “presentation parameters” refers to control values used to adjust how guidance text is presented to a user, including at least an audio volume level, a speaking rate factor, a pitch factor, a number of playback repetitions, and optionally timing or sequencing information.

The term “speech synthesis processing” refers to computational processing that converts text data such as guidance text into an audio signal representing synthetic speech, using a text-to-speech engine or similar software module.

The term “bone conduction transmission unit” refers to a hardware and software component configured to receive an audio signal, convert the audio signal into mechanical vibration by driving a transducer, and transmit the vibration through a user's skull to the inner ear, thereby allowing the user to perceive sound without relying solely on air conduction through the ear canal.

The term “information providing unit” refers to a hardware and software component configured to present information to a user, including at least an audio output device, and optionally visual or tactile output devices, and to output guidance information, alerts, or explanations based on processed system data.

The term “portable information processing device” refers to a computing device that can be worn or carried by a user, including at least a processor, a memory, communication interfaces, audio input and output hardware, motion sensors, and a power source, and that executes a terminal application implementing at least part of the audio signal processing and emotion recognition.

The term “server device” refers to an information processing apparatus deployed in a networked environment, including at least one processor, at least one memory, a network interface, and database management functionality, and configured to execute server-side components of emotion recognition, prompt sentence construction, generative AI cooperation, and guidance control.

The term “database management unit” refers to a hardware and software component, such as a database management system, configured to store, organize, and retrieve data including user attribute information, location history, emotional state history, biometric history, and state information received from portable information processing devices.

The term “service interface” refers to an application programming interface or communication interface through which the system transmits prompt sentences to a generative AI model and receives guidance text or other generated outputs, using a defined protocol over a network.

The term “network interface” refers to hardware and software configured to enable communication between the system components and external devices or services over a communication network, using wired or wireless communication protocols.

In one embodiment, terminal, server, and user cooperate to implement the invention as follows.

Terminal is a portable information processing device worn or carried by user. Terminal includes at least one processor, a memory, an audio input circuit with at least one microphone, an audio codec, an audio amplifier, a bone conduction transducer, motion sensors such as a three-axis accelerometer and a three-axis gyroscope, at least one location interface such as a satellite positioning module and a wireless communication interface, and a short-range communication interface for connecting to a biometric sensor such as a heart-rate monitor.

Terminal executes a mobile operating system, such as a general mobile OS, and executes a terminal application implementing at least a part of audio signal processing, provisional emotion recognition, and network communication.

Server is an information processing apparatus deployed in a data center or cloud environment.

Server includes at least one central processing unit, a memory, a non-volatile storage device, and a network interface. Server executes a server operating system, such as a general server OS, and runs an application framework, such as a script-language web framework, together with a database management system, such as a relational database and a time-series extension.

Server executes modules for integrated emotion recognition, prompt sentence construction, generative AI cooperation, control of presentation parameters, and communication with multiple terminals.

User is an elderly person or a care-requiring person who wears or carries terminal during daily life in a care facility or a home-care environment. User receives guidance, reminders, and alerts through bone conduction audio output while continuing to perceive ambient sounds through air conduction.

Terminal uses its audio collection unit to capture sound around user and utterances of user.

The audio collection unit includes at least one microphone, an analog-to-digital converter in the audio codec, and an audio input driver provided by the mobile operating system. Terminal configures the audio driver to sample monaural pulse-code modulation audio at, for example, 16 kHz and 16-bit resolution. Terminal stores successive fixed-length frames, such as 20-millisecond frames, in a ring buffer in memory. Terminal time-stamps each frame using a monotonic system clock to maintain synchronization with sensor data.

Terminal uses its audio signal processing unit to perform digital signal processing on the captured audio frames. Terminal applies a window function such as a Hamming window to each frame and calls a fast Fourier transform routine from a digital signal processing library such as a general FFT library or a platform-provided DSP API. Terminal calculates a magnitude spectrum for each frame and maintains a noise profile by averaging spectra for frames labeled as non-speech by a voice activity heuristic. Terminal performs spectral subtraction by subtracting the noise profile from the current spectrum, limiting negative values to zero, and thus obtains a noise-reduced spectrum. Terminal applies a mel filterbank to the noise-reduced spectrum, takes the logarithm of each mel channel, and performs a discrete cosine transform to obtain mel-frequency cepstral coefficients. Terminal aggregates these MFCCs with additional features such as frame energy and pitch estimates to form acoustic feature vectors.

Terminal detects important sounds and speech sections using these acoustic feature vectors.

Terminal loads a small acoustic event detection model, for example a feed-forward neural network with two or three hidden layers, quantized for execution on a mobile inference engine such as a lightweight neural network runtime. Terminal inputs a sliding window of consecutive acoustic feature frames into the model and obtains a vector of probabilities for predefined event classes such as alarm, caregiver call, notification tone, and background.

Terminal compares each probability against a threshold and, if a probability for a specific event remains above its threshold for a predefined minimum duration, registers an important sound event with type and time range in an event list. Terminal runs a voice activity detection algorithm, which may be a combination of energy thresholding and a small recurrent neural network, to mark speech sections, and stores start and end timestamps of each section.

Terminal uses a speech content acquisition unit to perform automatic speech recognition on audio corresponding to detected speech sections. Terminal passes a speech section, consisting of a sequence of PCM frames, to a speech recognizer. Terminal may use an on-device recognition engine such as a small-vocabulary recognizer, or may call a remote speech-to-text service via an HTTPS request when connectivity and policy allow. Terminal receives a recognized text string in a natural language such as Japanese. Terminal performs tokenization using a Japanese morphological analysis library, and constructs a token list annotated with part-of-speech tags. Terminal compares each token against a predefined vocabulary set that includes words like “toilet”, “it hurts”, “scary”, “I want to go home”, and “help me”. Terminal records for each keyword whether it appears, the number of occurrences, and the token positions.

Terminal uses an emotion recognition unit implemented as a lightweight neural network to estimate a provisional emotional state and a stress index. Terminal aggregates acoustic features for the speech section by computing, for example, average loudness, pitch mean and variance, speaking rate derived from token count per second, and pause statistics derived from silent intervals between speech segments. Terminal encodes keyword presence as a binary or count vector. Terminal acquires biometric information such as heart rate and heart-rate variability from a connected sensor via a short-range communication interface using a standardized protocol, and computes summary features such as mean heart rate and variation over a recent time window. Terminal concatenates these elements into a feature vector.

Terminal passes the feature vector into a compact neural network model. In one embodiment, the model has an input layer sized to the number of features, one or two hidden layers with rectified linear activation functions, a dropout layer for regularization, and an output softmax layer producing probability values for discrete emotional states such as normal, mild anxiety, high anxiety, confusion, and agitation. Alternatively, an output linear neuron can produce a continuous stress index. Terminal selects the label with the highest probability as the provisional emotional state and outputs the continuous value as the stress index.

Terminal uses a location information acquisition unit to determine location-related information and semantic location. Terminal obtains global positioning data through a satellite positioning module and indoor location data through a wireless communication interface such as a wireless local area network interface, which reports identifiers and signal strengths of access points. Terminal maps this raw information to semantic location labels, such as third-floor north corridor or staircase area, using a stored mapping table or a simple machine-learning classifier. Terminal reads accelerometer and gyroscope data at a high sampling rate, calculates derived motion signals such as acceleration magnitude, orientation change, and step events, and evaluates conditions for fall detection and wandering patterns using algorithms that detect rapid acceleration peaks followed by inactivity, or repeated back-and-forth motion along a corridor.

Terminal aggregates the provisional emotional state, stress index, recognized keywords, important sound events, semantic location, movement speed and direction, fall flag, wandering flag, and biometric indicators into a structured state object in memory. Terminal encodes this state object as a JavaScript Object Notation structure with named fields and transmits it to server using an HTTPS POST request through the mobile operating system networking stack. Terminal optionally compresses or batches multiple state objects to reduce network overhead.

Server receives the state object and stores its contents in a database management system.

Server uses a relational schema to store static user attribute information and uses time-series structures to store time-indexed records of emotional states, stress indices, positions, biometric indicators, and events. Server indexes these records by user identifier and time, enabling efficient queries for recent history.

Server performs integrated emotion recognition using an emotion recognition unit implemented as a neural network with temporal modeling capability, such as a recurrent neural network or a temporal convolutional network. Server constructs input sequences by retrieving, for a given user, a sliding window of recent state records including provisional emotion labels, stress indices, positions, motion flags, biometric values, and events. Server encodes categorical values as one-hot vectors and normalizes continuous values. Server stacks these vectors into a time-ordered tensor and feeds the tensor into the model.

In one example, server uses a recurrent neural network including long short-term memory layers with hidden units sized according to the number of features, followed by a fully connected layer that outputs a refined emotional state probability distribution and a refined stress index. Server trains this model offline using historical labeled data stored in the database. During training, server minimizes a loss function such as a weighted sum of cross-entropy loss for emotional state classification and mean squared error for stress index regression. Server updates model weights by applying stochastic gradient descent or a variant such as Adam. Server may use data augmentation techniques such as adding noise to acoustic feature inputs or jitter to timing features during training to improve robustness.

Server produces a refined emotional state label and updated stress index that account for long-term patterns such as sustained anxiety or repeated night-time wandering. Server optionally computes a risk score for safety events by applying rule-based logic or a separate classifier that considers refined emotional state, semantic location, and time of day. By performing this processing on server using a temporal model and history stored in the database, server improves recognition accuracy compared to naive, instantaneous classification.

Server uses a generative AI cooperation unit to construct a prompt sentence to drive a generative AI model. Server retrieves user attribute information such as age, cognitive level, and preferred speaking style from the relational database. Server combines this information with the current refined emotional state, updated stress index, semantic location, and recent speech content. Server uses a template mechanism implemented as string manipulation code or a template engine to insert these values into one or more natural language prompt templates. For example, server constructs a prompt sentence such as:

“You are a Japanese assistant in a nursing facility who gently guides elderly residents.

The user is an 80-year-old woman with mild dementia. She is currently in the 3rd floor north corridor, appears mildly anxious, and may have forgotten where the toilet is, having said ‘Where was the toilet again?’.

Please generate 1-2 Japanese sentences in polite form (desu/masu polite style) that calmly reassure her and simply tell her where the toilet is. Avoid technical terms and use expressions that provide a sense of safety.”

In another case, server constructs a prompt sentence such as:

“You are a kind health advisor for elderly people.

The user is a man in his seventies who is slightly anxious but can understand basic daily conversation. It is now 8 a.m., which is the time for his blood-pressure medicine.

Please generate 1-2 Japanese sentences in polite form (desu/masu polite style) that gently remind him to take his medicine at a relaxed pace, mentioning the importance of the medicine while keeping the content reassuring.”

In yet another case, server constructs a prompt sentence such as:

“You are a Japanese assistant acting as a professional caregiver in a nursing facility who reassures elderly residents.

The user is a man in his eighties with advanced dementia. It is now 2 a.m., and he is repeatedly walking up and down the hallway in the facility, showing strong anxiety and confusion.

Please generate 1-3 Japanese sentences in polite form (desu/masu polite style) that calmly reassure him and gently encourage him to return to his room. Do not scold him; use wording that makes him feel safe.”

Server passes the constructed prompt sentence and model parameters such as temperature and maximum tokens to a generative AI model through a service interface. The generative AI model is a large language model running on an external AI service or on another server, and is trained on large corpora of text using a neural network architecture such as a transformer architecture with multi-head self-attention layers and feed-forward layers. During training, the generative AI model minimizes a cross-entropy loss between predicted and actual next tokens and updates parameters with gradient-based optimization. At run time, the model generates text conditioned on the prompt sentence, using decoding strategies such as greedy decoding or sampling within a probability mass defined by top-p or temperature.

Server receives guidance text from the generative AI model, cleans up formatting, and optionally applies filters to remove or replace undesired tokens or phrases that would not be appropriate for the target user group. Server does not rely on manual operators for this filtering; instead, server uses deterministic rules such as maximum character counts, forbidden word lists, and pattern matching. By constructing structured prompt sentences and applying rule-based post-processing, server constrains the generative AI output to a narrow, safety-oriented domain, thereby improving reliability and reducing the need for human supervision.

Server uses a control unit to determine presentation parameters for the guidance text. Server defines, in memory, a mapping table or rule set that associates refined emotional state and stress index ranges with parameter values for volume, speaking rate, pitch, and number of repetitions. For instance, server may define that mild anxiety corresponds to a speaking rate factor of 0.8, pitch slightly lower than a neutral baseline, and a single repetition, while high anxiety near a dangerous area corresponds to a speaking rate factor close to 1.0, a clear but not aggressive pitch, higher volume within safe limits, and multiple repetitions. Server evaluates the refined emotional state and stress index, selects corresponding parameter values, and may also adapt parameters to user attributes such as hearing characteristics stored in the database.

Server packages the guidance text and selected presentation parameters into a structured response object and sends it to terminal via the network interface. Server thus offloads computationally intensive operations such as integrated emotion recognition and generative AI interaction from terminal to server, while terminal performs lightweight local processing to reduce upstream data volume.

Terminal receives the guidance text and presentation parameters, and uses a speech synthesis engine provided by the mobile operating system to generate an audio waveform. Terminal sets synthesis options such as voice type, speaking rate, and pitch according to the parameters.

Terminal estimates ambient noise levels by analyzing audio frames during non-speech intervals and reads user-specific hearing profiles from local storage. Terminal computes an effective audio gain by combining server-specified volume factor, measured noise, and the hearing profile, and configures the audio codec and amplifier accordingly. Terminal sends the synthesized audio signal to the bone conduction transducer, which converts the signal into mechanical vibration transmitted through the skull to the inner ear. Because bone conduction leaves the ear canal open, user continues to perceive environmental sounds such as other people's speech or alarms, improving safety.

This architecture produces technical advantages beyond merely automating human guidance.

Terminal performs on-device noise reduction, feature extraction, and provisional emotion recognition using specific signal processing and machine-learning algorithms, thereby transmitting compact, structured state objects instead of raw audio streams. This reduces network bandwidth consumption, lowers transmission latency, and reduces server-side processing load. Server, in turn, uses temporal neural models and historical data stored in a database to refine emotional state and risk assessment, achieving higher accuracy and earlier detection of dangerous patterns such as escalating anxiety combined with wandering near exits. Server systematically constructs prompt sentences that encode emotional, contextual, and user-attribute constraints, thereby reducing variance in outputs from the generative AI model and simplifying automated post-processing. The combination of rule-based parameter mapping and closed-loop feedback between emotion recognition and audio rendering allows the system to optimize speech synthesis parameters in a way that human caregivers cannot reliably achieve in real time.

In another embodiment, server and terminal implement alternative neural network architectures. For instance, terminal may use a convolutional neural network that directly ingests spectrogram patches for provisional emotion classification, while server may use a temporal convolutional network for integrated emotion recognition. The generative AI model may be replaced by a smaller domain-specific language model fine-tuned on care-facility dialogs. The prompt sentence construction logic may be adapted to different languages by exchanging template libraries, while preserving the same control flow and data structures.

In a further embodiment, the system may use additional sensors such as a pressure sensor in the bed, door sensors, or environmental sensors for temperature and light. Terminal or server integrates these sensor readings into the same state object and feature vectors, extends the neural network inputs, and adjusts prompt sentences accordingly. For example, if user gets out of bed at unusual hours and repeatedly approaches an exit, server constructs prompt sentences instructing the generative AI model to generate calming messages that encourage user to return to bed or to a safe area.

By defining specific data structures for state objects, acoustic feature vectors, semantic locations, and presentation parameters, and by defining concrete neural architectures, training procedures, and rule-based logic for parameter mapping, the invention improves core computer technology. The system optimizes processing distribution between edge devices and centralized servers, uses reduced and structured data for communication, thereby lowering bandwidth and improving response times, and integrates generative AI into a constrained, safety-critical pipeline rather than using it as an uncontrolled text generator. These configurations provide a clear causal relationship between the technical arrangements and the effects of improved emotion recognition accuracy, reduced communication overhead, more stable generative outputs, and more appropriate and intelligible real-time guidance for user in a care environment.

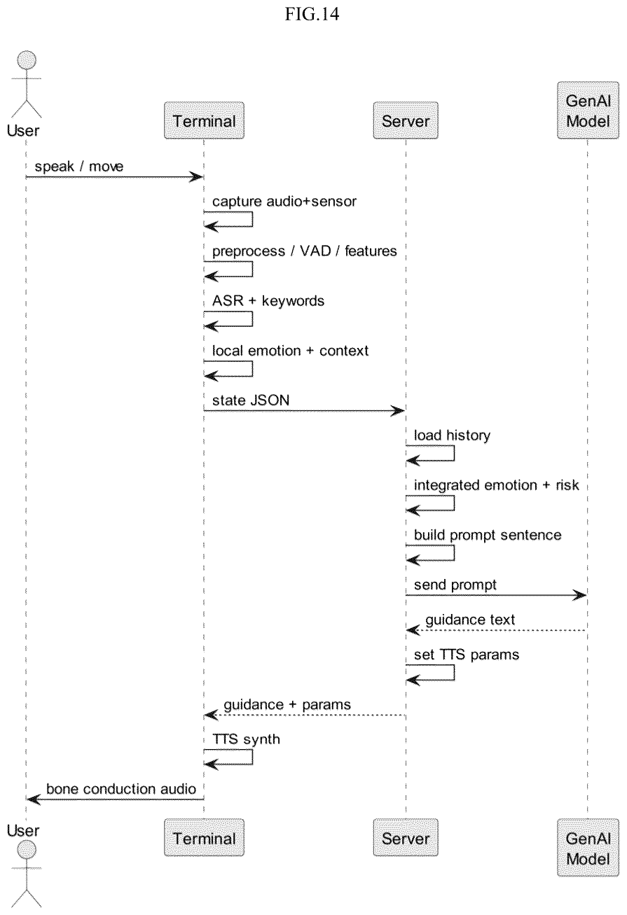

The following describes the processing flow using FIG. 14.

### Step 1

Terminal initializes hardware resources and background services.

Terminal takes as input configuration parameters stored in local memory, including sampling rates, buffer sizes, and network endpoints. Terminal activates the microphone and audio codec through the mobile OS audio API, sets the sampling rate (for example, 16 kHz, 16-bit PCM), and allocates a ring buffer for audio frames. Terminal registers listeners for the accelerometer and gyroscope with the sensor framework, sets their sampling rates (for example, 50-100 Hz), and allocates buffers for motion data. Terminal enables the satellite positioning module and wireless communication interface for Wi-Fi scans, sets update intervals, and initializes a short-range communication interface for connection to a heart-rate sensor. Terminal starts background services for audio capture, sensor collection, and network communication. The output of this step is an initialized set of hardware and software components ready to acquire continuous audio, motion, location, and biometric data.

### Step 2

Terminal acquires raw audio frames and sensor data continuously.

Terminal takes as input analog signals from the microphone, motion signals from the accelerometer and gyroscope, radio signals for positioning, and biometric signals from an external device. Terminal uses the audio driver to convert analog audio to digital PCM frames every fixed duration (for example, 20 ms), tags each frame with a timestamp, and stores it in the audio buffer. Terminal reads accelerometer and gyroscope values at the configured rate, timestamps them, and stores them in a motion buffer. Terminal periodically obtains GNSS coordinates and Wi-Fi access point identifiers with their signal strengths, and stores them as location samples. Terminal receives heart-rate readings from the biometric sensor via the short-range interface and stores them as time-stamped values. The output of this step is a set of synchronized time-series data streams representing audio, motion, location, and biometric information.

### Step 3

Terminal performs audio pre-processing and feature extraction.

Terminal takes as input a sequence of time-stamped PCM audio frames from the audio buffer.

Terminal applies a window function such as a Hamming window to each frame and calls a fast Fourier transform function from a digital signal processing library to compute the frequency spectrum. Terminal maintains a noise profile by averaging spectra during low-energy, non-speech periods identified by a simple energy threshold. Terminal subtracts the noise profile from each new spectrum, clamps negative values to zero, and thus performs spectral subtraction. Terminal passes the noise-reduced spectrum through a mel filterbank, computes the log of each mel band, and applies a discrete cosine transform to obtain mel-frequency cepstral coefficients. Terminal also computes frame-level energy and a pitch estimate, for example using an autocorrelation method. The output of this step is a time-aligned sequence of acoustic feature vectors, including MFCCs, energy, and pitch, stored in a feature buffer.

### Step 4

Terminal detects important sounds and speech sections.

Terminal takes as input the acoustic feature vectors from the feature buffer and the corresponding timestamps. Terminal feeds sliding windows of feature vectors into an acoustic event detection model, such as a small feed-forward neural network running on a mobile inference engine. Terminal calculates class probabilities for event types including alarm, caregiver call, notification tone, and background. Terminal compares the probabilities with thresholds and, when a probability for an event stays above its threshold over a minimum number of frames, registers an important sound event with its type and time interval in an event list. Terminal simultaneously applies a voice activity detection algorithm that uses energy, zero-crossing rate, and optionally a small neural network to classify frames as speech or non-speech. Terminal groups consecutive speech frames into speech sections and records their start and end times. The output of this step is a list of important sound events and a list of detected speech sections with precise timing.

### Step 5

Terminal performs speech recognition and keyword extraction.

Terminal takes as input one speech section defined by start and end timestamps, and retrieves the corresponding PCM frames from the audio buffer. Terminal supplies these frames to a speech recognition engine, either on-device or via a network call to a remote speech-to-text service. Terminal receives, as a result of pattern matching and probabilistic decoding in the recognizer, a recognized text string representing the user's utterance. Terminal uses a natural language processing library to tokenize the string and to perform morphological analysis, obtaining tokens with part-of-speech information. Terminal compares each token against a pre-defined vocabulary set containing important terms such as “toilet”, “it hurts”, “scary”, “I want to go home”, and “help me”. Terminal generates a keyword record that lists which keywords appear, how many times they appear, and their positions in the token sequence. The output of this step is a pair consisting of the recognized text and the associated keyword record.

### Step 6

Terminal estimates a provisional emotional state and stress index.

Terminal takes as input acoustic feature vectors for the speech section, the recognized text, the keyword record, and recent biometric data such as heart-rate values. Terminal computes summary statistics from acoustic features, including average and variance of loudness, pitch contour, speaking rate (tokens or syllables per second), and pause durations between phrases.

Terminal converts the keyword record into a feature vector indicating presence and counts of specific words. Terminal aggregates biometric readings over a time window to compute metrics such as mean heart rate and heart-rate variability. Terminal concatenates all these values into a single feature vector. Terminal feeds this feature vector into an on-device emotion classification model implemented as a small neural network, which applies weighted sums, activation functions, and a softmax output layer to generate probabilities for emotional categories such as normal, mild anxiety, high anxiety, confusion, and agitation. Terminal selects the category with the highest probability as the provisional emotional state and reads a continuous value from a regression neuron as the stress index. The output of this step is the provisional emotional state label and the numeric stress index.

### Step 7

Terminal determines semantic location and motion context.

Terminal takes as input raw location samples from the GNSS receiver and Wi-Fi interface, as well as motion samples from the accelerometer and gyroscope. Terminal maps GNSS coordinates or sets of Wi-Fi access point identifiers and signal strengths to semantic locations using a stored mapping table or a simple classifier. Terminal aggregates motion samples to compute speed, direction, and step patterns, and calculates acceleration magnitudes to detect sudden changes. Terminal applies a fall detection algorithm that flags a fall when a large acceleration spike occurs followed by a period of low motion. Terminal analyzes short-term trajectories to detect wandering, for example by identifying repeated back-and-forth movements within the same corridor segment over a defined time window. The output of this step is semantic location information, movement speed and direction, a fall flag, and a wandering flag.

### Step 8

Terminal assembles a state object and sends it to server.

Terminal takes as input the provisional emotional state, the stress index, the recognized text and keyword record, the important sound events, the semantic location and motion context, and recent biometric measurements. Terminal constructs a state object as a structured record with fields such as user identifier, timestamp, emotional state, stress index, semantic location, coordinates or area identifier, movement speed, movement direction, fall flag, wandering flag, keyword list, and biometric values. Terminal serializes this record into a JSON string using a data-serialization library. Terminal opens an HTTPS connection to server using the networking API, sets the JSON string as the body of a POST request, and sends the request to a specific endpoint. The output of this step is a network message containing the state object delivered to server.

### Step 9

Server receives, validates, and stores state information.

Server takes as input the HTTP request containing the JSON-encoded state object from terminal. Server uses its web application framework to parse the request, extract the JSON body, and deserialize it into an in-memory data structure. Server validates essential fields such as user identifier, timestamp, and emotional state, checking types and ranges. Server writes static or slowly changing information to relational tables and appends time-stamped values such as provisional emotional state, stress index, position, and biometric indicators to time-series tables. Server indexes the new entries by user identifier and time, enabling efficient retrieval. The output of this step is an updated database containing the latest state record and its link to past records.

### Step 10

Server performs integrated emotion recognition using historical context.

Server takes as input the latest state record and a set of historical records retrieved from the database for the same user over a recent time window. Server converts these records into input tensors by encoding categorical labels as one-hot vectors and normalizing numerical values. Server orders these vectors by time to form sequences and feeds the sequences into an integrated emotion recognition model, such as a recurrent neural network with long short-term memory cells. The model applies matrix multiplications, non-linear activations, and recurrent updates to maintain a hidden state that captures temporal patterns. Server obtains from the model a refined emotional state distribution and an updated stress index that reflect both current and past conditions. Server selects the most probable emotional category as the refined emotional state. The output of this step is the refined emotional state label and the updated stress index for the user.

### Step 11

Server evaluates safety risk and updates risk indicators.

Server takes as input the refined emotional state, the updated stress index, recent semantic location history, and motion flags such as fall and wandering. Server applies rule-based logic or a simple classifier that assigns risk levels, for example normal, elevated, or high, based on combinations such as high anxiety near a staircase, repeated wandering near an exit at night, or detected fall. Server writes the risk level and any relevant flags to the database and may generate internal notifications for caregiver dashboards. The output of this step is a risk assessment value and an updated risk record stored for the user.

### Step 12

Server constructs a context-rich prompt sentence for the generative AI model.

Server takes as input the refined emotional state, the updated stress index, the current semantic location, the recognized keywords, the latest speech content, the current time, and user attribute information retrieved from the database, such as age, cognitive level, and preferred speaking style. Server selects a template appropriate to the situation, for example a guidance template for toilet location, medication reminders, or nighttime wandering. Server populates template placeholders with concrete values (for example, “80-year-old woman with mild dementia”, “3rd floor north corridor”, “mildly anxious”, “said ‘Where was the toilet again?’”). Server concatenates static instructional text and dynamic fields to form a complete prompt sentence. For instance, server generates a prompt such as:

“You are a Japanese assistant in a nursing facility who gently guides elderly residents.

The user is an 80-year-old woman with mild dementia. She is currently in the 3rd floor north corridor, appears mildly anxious, and may have forgotten where the toilet is, having said ‘Where was the toilet again?’.

Please generate 1-2 Japanese sentences in polite form (desu/masu polite style) that calmly reassure her and simply tell her where the toilet is. Avoid technical terms and use expressions that provide a sense of safety.”

The output of this step is a fully constructed prompt sentence string ready to be sent to the generative AI model.

### Step 13

Server calls the generative AI model and obtains guidance text.

Server takes as input the prompt sentence and model invocation parameters such as model name, temperature, and maximum token count. Server builds an API request using an AI service client library, sets the prompt field to the constructed prompt sentence, and sends the request via HTTPS to a generative AI service endpoint. The generative AI model, implemented as a transformer-based neural network, processes the prompt, performs multiple layers of self-attention and feed-forward computations, and generates a completion sequence token by token. Server receives the response containing the generated text, extracts the text portion, and applies simple checks such as truncating the text if it exceeds a length limit and scanning for forbidden words. The output of this step is cleaned guidance text tailored to the user's current situation.

### Step 14

Server determines audio presentation parameters for the guidance text.

Server takes as input the refined emotional state, the updated stress index, user hearing characteristics, and optional risk level. Server consults a mapping table or rules defined in memory that associate emotional categories and stress ranges with audio parameters such as speaking rate factor, pitch factor, volume factor, and number of repetitions. Server may reduce the speaking rate and pitch for anxious states, increase volume slightly for noisy environments, or increase repetitions for users with cognitive impairment. Server composes a presentation parameter record containing these values. The output of this step is a set of presentation parameters corresponding to the guidance text.

### Step 15

Server sends guidance text and presentation parameters to terminal.

Server takes as input the guidance text and the presentation parameter record. Server constructs a response object containing fields for guidance text, speaking rate factor, pitch factor, volume factor, and repetition count. Server serializes this object to JSON and sends it as the body of an HTTPS response to the terminal that previously transmitted the state object.

The output of this step is a network message delivered to terminal, containing all information needed to synthesize and present the guidance.

### Step 16

Terminal synthesizes speech from the guidance text.

Terminal takes as input the guidance text and presentation parameters from the server response. Terminal configures the text-to-speech engine offered by the mobile operating system, selecting a Japanese voice and setting the speaking rate and pitch according to the received factors. Terminal passes the guidance text to the engine, which tokenizes the text, looks up phonetic representations, and generates an audio waveform by processing the sequence through an acoustic model and a vocoder. Terminal receives the synthesized audio frames into an output buffer. The output of this step is an audio signal representing the guidance text, parameterized for the desired speaking rate and pitch.

### Step 17

Terminal adjusts playback gain and drives the bone conduction transducer.

Terminal takes as input the synthesized audio signal, the volume factor, the repetition count, and recent estimates of ambient noise and user hearing profile stored locally. Terminal computes an effective gain by combining the volume factor with a function of ambient noise level and the hearing profile, while enforcing upper limits to avoid excessive loudness.

Terminal programs the audio codec and amplifier with this gain. Terminal streams the audio frames to the amplifier, which converts the digital signal to an analog voltage to drive the bone conduction transducer. Terminal repeats playback for the specified number of repetitions, inserting short pauses if configured. The output of this step is mechanical vibration produced by the transducer and transmitted through the user's skull to the inner ear, allowing user to perceive the guidance.

### Step 18

User listens to the guidance and responds.

User takes as input the guidance perceived through bone conduction, along with ambient sounds received through the ears. User interprets the message, such as directions to a toilet, a reminder to take medicine, or an instruction to return to a room, and adjusts behavior accordingly, for example by changing walking direction, opening a door, or returning to bed.

User may express relief or acknowledgment verbally, such as saying “Oh, here it is.”, or may show calmer movement patterns. The output of this step is new speech and motion by user, which terminal again captures as audio and sensor signals, feeding them back into Step 2 and subsequent steps to continue adaptive guidance based on the generative AI model and dynamically constructed prompt sentences.

The data generation model 58 is a so-called generative artificial intelligence (AI).

Examples of the data generation model 58 include generative Als such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

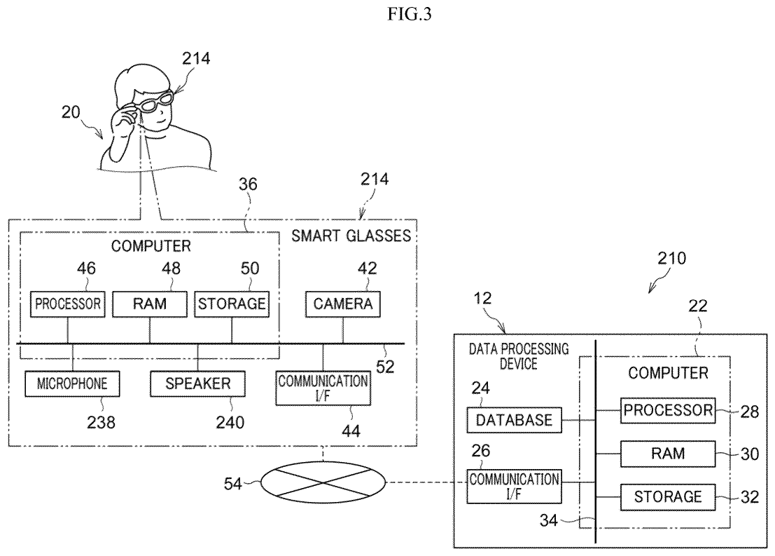

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52.

The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

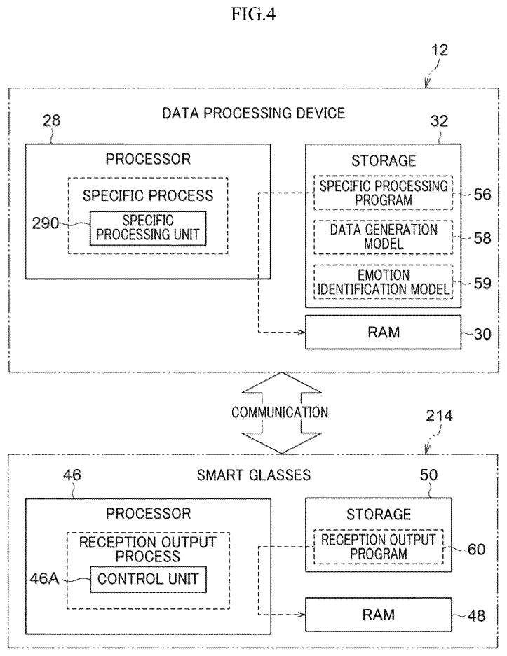

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

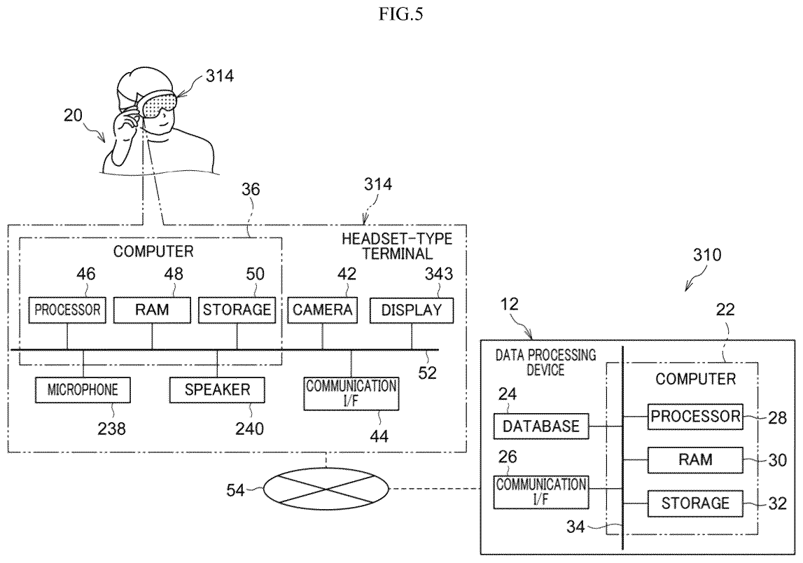

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

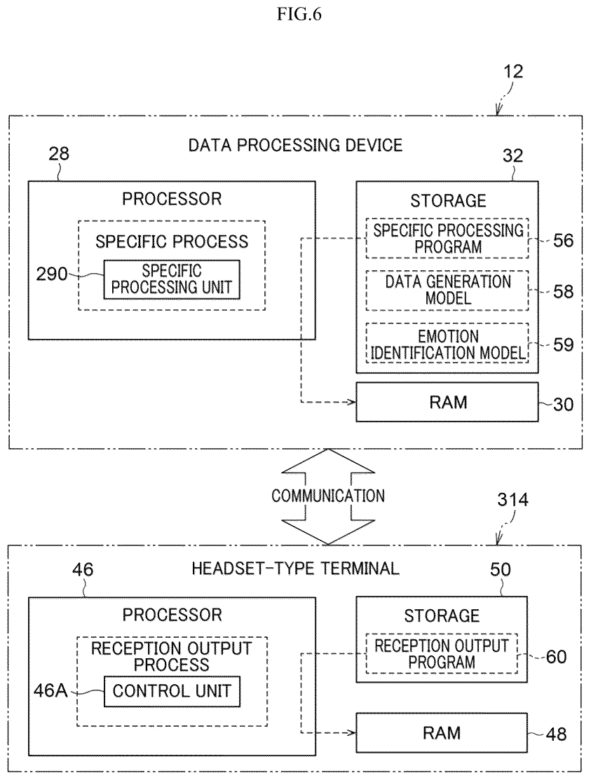

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12.

For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

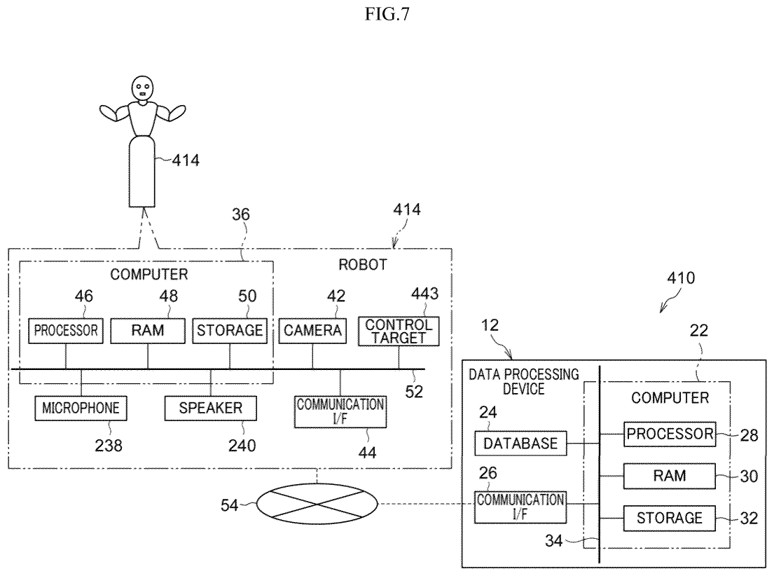

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

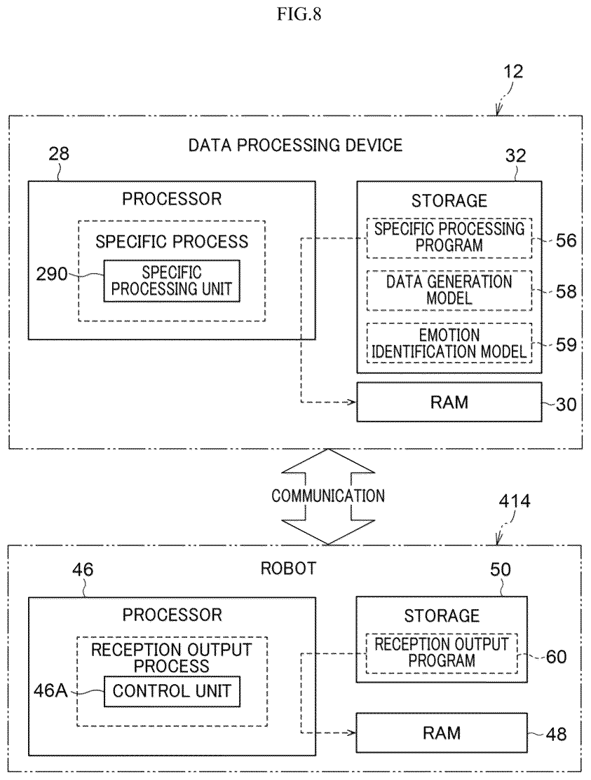

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

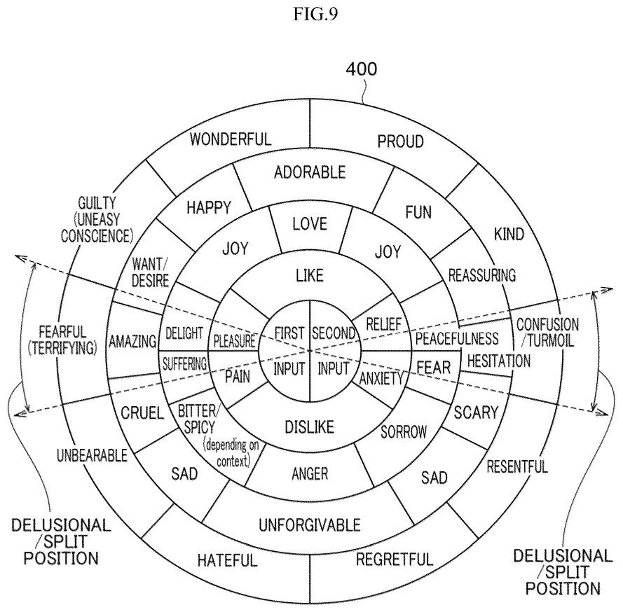

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

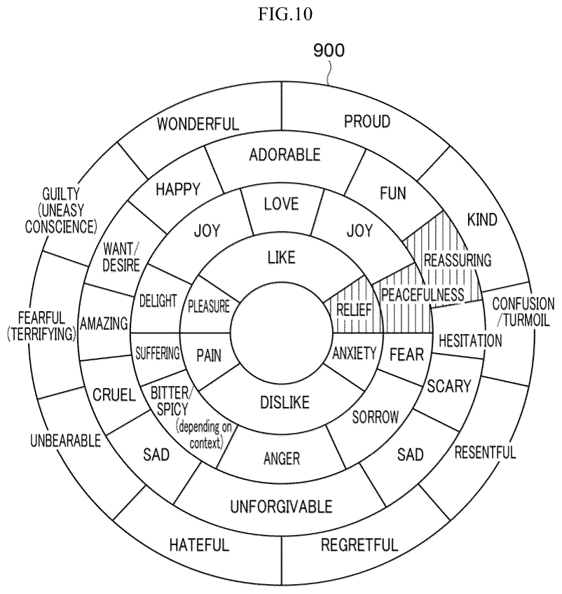

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC).

Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire sound in a surrounding environment, convert the acquired sound into an electrical signal, and store the electrical signal in a storage medium,
segment the electrical signal into time-domain and frequency-domain frames, perform short-time analysis on the frames, identify a noise component and a speech component based on a result of the analysis, and generate a processed speech signal in which the noise component is suppressed and the speech component is emphasized,
detect a speech section included in the processed speech signal, perform speech recognition processing on the speech section, extract an important phrase based on a stored phrase group, and specify the speech section including the important phrase as important speech,
convert the important speech into a vibration signal and output the vibration signal to be transmitted to an inner ear of a user via a head portion of the user,
calculate a position, a movement speed, and a movement direction of the user based on a satellite positioning signal, a wireless communication signal, and an output of an inertial sensor, and generate position history information,
determine an indoor or outdoor position state of the user based on the position history information and wireless environment information, and generate region information corresponding to the determined position state,
acquire environment information, movement information, and sales information from an external information source based on the region information, and temporarily store the acquired information,
calculate a relevance value for each of the acquired pieces of information based on the position history information, the extracted important phrase, and use history information of the user, rank the acquired pieces of information according to the relevance value, and select presentation target information,
convert the presentation target information into text for audio output, and generate audio data for output as the vibration signal by mixing the text for audio output with the processed speech signal, and
create a generation instruction sentence including an input sentence that includes the position state of the user, the extracted important phrase, and the acquired information, transmit the generation instruction sentence to a generative information processing model, obtain a response sentence from the generative information processing model, and update at least one of the text for audio output and a condition of the ranking based on the response sentence.

### Supplementary 2

The system according to supplementary 1,
wherein the processor is configured to
perform time-window processing and short-time frequency-domain transformation on the electrical signal, input a result of the transformation as a feature into a machine learning model, generate a noise-suppression mask based on weight information output from the machine learning model for each time-frequency region, and generate the processed speech signal by applying the noise-suppression mask.

### Supplementary 3

The system according to supplementary 1,
wherein the processor is configured to
associate the acquired information from the external information source with a template sentence or the response sentence generated by the generative information processing model,
control a number and timing of notifications based on the position state of the user and behavior schedule information of the user, output a notification having high importance with priority over the processed speech signal, and postpone output of a notification having low importance until a time point at which a load on the user is determined to be low.

### Application Example 1

### Supplementary 1

A system comprising a processor,
wherein the processor is configured to
acquire an acoustic signal from an environment of a user, generate the acoustic signal as digital data, and dynamically control a directivity characteristic of an acoustic sensor in accordance with a motion state of the user,
perform noise suppression processing, acoustic event detection processing, speaker identification processing, and speech recognition processing on the acquired acoustic signal so as to extract high-priority speech information and acoustic event information,
convert the high-priority speech information into a vibration signal and output the vibration signal to a bone-conduction actuator so as to transmit the high-priority speech information to an inner ear of the user through a skull while allowing the user to perceive surrounding environmental sounds,
estimate a current position and a movement state of the user on a basis of satellite positioning information and wireless communication information and generate position information associated with area information of an indoor facility or geographic information of an outdoor space,
determine a situation of the user on a basis of the position information, the acoustic event information, and at least one of schedule information and health information of the user, and generate instruction information, alert information, or life-support information according to a result of the determination,
construct a prompt sentence in a natural language by using the instruction information, the alert information, or the life-support information as input conditions, input the prompt sentence to a generative AI model, and cause the generative AI model to generate a guidance text in the natural language, and
convert the guidance text into an audio signal by text-to-speech processing and output the audio signal to the user via the bone-conduction actuator.

### Supplementary 2

The system according to supplementary 1,
wherein the processor is configured to
execute time-frequency analysis processing and statistical signal processing on the acoustic signal by using an arithmetic circuit that executes a program, apply an acoustic event classification model and a speaker identification model to detect at least one of an alarm sound, a calling sound, and a help-requesting utterance, and embed context information including the position information, a detection result of the acoustic event classification model, and attribute information of the user into the prompt sentence so that the generative AI model generates a personalized guidance text according to the situation of the user.

### Supplementary 3

The system according to supplementary 1,
wherein the processor is configured to store history information including at least one of a movement history, a behavior history, and a support history of the user, perform adaptive control processing to adjust content of the prompt sentence and at least one of a length, an expression difficulty level, and an output timing of the guidance text on a basis of the history information, and thereby automatically and in real time perform at least one of evacuation guidance in an emergency, alerting in an area with a high fall risk, reminding of medication timing, and presenting surrounding safety information according to an outing schedule of the user in cooperation with the generative AI model.

### Example 2

### Supplementary 1

A system comprising a processor,
wherein the processor is configured to
acquire, by an audio acquisition unit, sound in an environment and output an audio signal representing the sound; and
perform, by an audio signal processing unit, frequency analysis and noise reduction processing on the audio signal to generate a noise-reduced audio signal, extract high-importance audio information from the noise-reduced audio signal, and generate audio feature quantities and a speech recognition result; and
estimate, by an emotion estimation unit, an emotional state of a user by inputting the audio feature quantities and the speech recognition result into a machine learning model, and output emotion information representing the emotional state; and
acquire, by a position acquisition unit, position information representing a current position of the user by using at least one of a satellite positioning system and a wireless communication network; and
generate, by a communication control unit, state information including the emotion information and the position information, and transmit the state information to a server via a communication network; and
receive, by the communication control unit, information transmitted from the server, the information including environment information or service information, and generate, by a bone-conduction output unit, a vibration signal for transmitting audio corresponding to the information and the high-importance audio information to an inner ear of the user via bone conduction, and output the vibration signal; and
execute, by a generation information processing unit provided in the server, processing of receiving the state information via the communication network, acquiring, based on the position information and the emotion information included in the state information, the environment information or the service information from an external information providing source, calculating a presentation priority for each piece of the acquired environment information or service information, selecting information to be presented based on the presentation priority, generating a prompt sentence in a natural language including at least the position information and the emotion information, inputting the prompt sentence into a generative AI model, receiving a response from the generative AI model, and setting or updating, based on the response, an information selection rule or a notification method used for the selection of the information to be presented; and
execute, by an information providing unit provided in the server, processing of providing, to the processor of a terminal worn by the user, user-oriented information obtained by selecting the environment information or the service information in accordance with the information selection rule or the notification method that has been set or updated by the generation information processing unit.

### Supplementary 2

The system according to supplementary 1,
wherein the processor is configured to
estimate, by the emotion estimation unit, the emotional state of the user by inputting time-series data of the audio feature quantities and the speech recognition result into a neural network model that outputs scores for a plurality of emotion categories, to generate the emotion information including an emotion label and a score for each of the plurality of emotion categories,
cause the communication control unit to attach user identification information and time information to the emotion information and the position information to generate the state information, and to transmit the state information to the server, and
cause the information providing unit to score at least one of weather information, mobile body information, and commercial facility information acquired based on the state information, and, in accordance with the scores, reduce a presentation frequency of advertisement-type information while preferentially providing, to the terminal, warning information or time-sensitive information.

### Supplementary 3

The system according to supplementary 1,
wherein the processor is configured to
cause the generation information processing unit to generate, as the prompt sentence, an instruction sentence or a question sentence in a natural language including at least the position information, the emotion information, and an information provision condition, to input the prompt sentence into the generative AI model, to acquire a response including at least one of a rule proposal and a template sentence relating to a notification frequency, a notification timing, an expression method of information content, and priority assignment for information categories, and to automatically update, based on the response, a notification template and a presentation-priority calculation parameter used by the information providing unit for providing the environment information or the service information to the user.

### Application Example 2

### Supplementary 1

A system comprising a processor,
wherein the processor is configured to
acquire sound around a user or utterance of the user as audio signals by controlling an audio collection unit including an acoustic sensor, and store the audio signals in a buffer,
perform frequency analysis and noise suppression on the audio signals by controlling an audio signal processing unit, calculate acoustic feature quantities including at least spectral features and prosodic features, and detect important sounds and speech sections,
perform speech recognition processing on audio corresponding to the detected speech sections, generate text data representing speech content, and extract keywords from the text data based on a predetermined vocabulary set by controlling a speech content acquisition unit,
estimate an emotional state of the user and a stress index of the user on the basis of the acoustic feature quantities, the text data and the extracted keywords, and biometric information indicating at least one physiological parameter of the user, by controlling an emotion recognition unit that executes an emotion estimation algorithm,
acquire location-related information of the user or a terminal device worn or carried by the user by controlling a location information acquisition unit including at least one of a satellite positioning device and a wireless communication device, specify semantic location information in a facility or surrounding environment from the location-related information,
and detect a fall or a wandering pattern of the user on the basis of motion information,
generate a prompt sentence to be input to a generative AI model by controlling a generative AI cooperation unit on the basis of the emotional state of the user estimated by the emotion recognition unit, the location-related information acquired by the location information acquisition unit, and user attribute information including at least age, cognitive level, and preference of speaking style, transmit the prompt sentence to the generative AI model through a communication interface, and acquire guidance text generated by the generative AI model,
determine, by controlling a control unit, at least one presentation parameter among volume, speaking rate, pitch, and number of repetitions for presenting the guidance text, on the basis of the emotional state and the stress index estimated by the emotion recognition unit,
perform speech synthesis processing on the guidance text using the presentation parameters, generate an audio signal, and control a bone conduction transmission unit so as to convert the audio signal into mechanical vibration and transmit the mechanical vibration to an inner ear of the user via a skull of the user,
and present guidance information for safety assurance and psychological reassurance of the user on the basis of at least one of a result of processing by the emotion recognition unit, a result of processing by the location information acquisition unit, and the guidance text acquired by the generative AI cooperation unit, by controlling an information providing unit including at least an audio output device.

### Supplementary 2

The system according to supplementary 1,
wherein the processor is configured to
execute at least a part of the audio signal processing and the emotion recognition on a portable information processing device running a terminal application,
wherein the processor, by controlling the terminal application, uses a digital signal processing library to perform a short-time Fourier transform and to calculate mel-frequency cepstral coefficients from the audio signals, and uses a lightweight machine learning model to classify a provisional emotional state of the user as the emotional state, and transmits the provisional emotional state and related feature quantities to a server through a network.

### Supplementary 3

The system according to supplementary 1,
wherein the processor is configured to
execute the generative AI cooperation on a server device running an information processing program,
wherein the processor, by controlling the information processing program, acquires, from a database management unit, the user attribute information, a location history, and an emotional state history, combines the user attribute information, the location history, and the emotional state history with a current emotional state and current location-related information to construct, by template generation processing, a situation description included in the prompt sentence, transmits the prompt sentence to the generative AI model through a service interface for the generative AI model provided inside or outside the server device, acquires, as the guidance text, a response generated by the generative AI model, performs a length check and an expression check on the guidance text, and transmits the guidance text together with the presentation parameters determined by the control unit to the portable information processing device through the network.

What is claimed is:

1. A system comprising:
circuitry configured to:
acquire, via a communication interface coupled to a packet-switched network, an audio signal from an acoustic sensor, convert the audio signal into a digital signal, and store the digital signal in a memory;
segment the digital signal into time-domain and frequency-domain frames, perform short-time spectral analysis on the frames, identify a noise component and a speech component based on the analysis, and generate a processed speech signal in which the noise component is suppressed and the speech component is emphasized;
detect a speech section in the processed speech signal, perform speech recognition processing on the speech section, extract a keyword based on a stored keyword group, and identify the speech section including the keyword;
convert the identified speech section into a vibration signal and output the vibration signal to an actuator;
calculate a position of a user based on at least one of a satellite positioning signal, a wireless communication signal, or an output of an inertial sensor, and generate position history data;
determine a position state of the user based on the position history data and wireless environment data, and generate region data corresponding to the determined position state;
acquire environment data and service data from an external information source via the packet-switched network based on the region data;
calculate a relevance value for each acquired data item based on the position history data, the extracted keyword, and use history data of the user, rank the acquired data items according to the relevance value, and select presentation target data;
convert the presentation target data into audio output data and generate combined audio data by mixing the audio output data with the processed speech signal for output via the actuator; and
construct an input prompt comprising the position state, the extracted keyword, and the acquired data, transmit the input prompt to a generative language model, receive a response, and update at least one of the audio output data or a ranking condition based on the response.

2. The system according to claim 1, wherein the circuitry is configured to calculate a movement speed and a movement direction of the user based on the satellite positioning signal, the wireless communication signal, and the output of the inertial sensor, and to include the movement speed and the movement direction in the position history data.

3. The system according to claim 1, wherein the circuitry is configured to determine the position state as an indoor position state or an outdoor position state based on the position history data and a signal strength of the wireless communication signal, and to generate the region data comprising at least one of a floor identifier or an area identifier for the indoor position state.

4. The system according to claim 1, wherein the circuitry is configured to perform the short-time spectral analysis by applying a window function to each frame, computing a short-time Fourier transform to obtain a complex spectrum, estimating a noise power spectrum, and suppressing the noise component by attenuating the noise power spectrum from the complex spectrum in each frequency bin.

5. The system according to claim 1, wherein the circuitry is configured to compute, for each frame of the digital signal, mel-frequency cepstral coefficients, log-mel filterbank energies, frame energy, spectral centroid, and fundamental frequency, and to concatenate per-frame feature vectors into a time-series feature array for use in at least one of the speech recognition processing or an emotion estimation model.

6. The system according to claim 5, wherein the circuitry is configured to input the time-series feature array into an emotion estimation neural network comprising at least one recurrent or attention-based layer, compute scores for a plurality of predefined emotion categories, apply a softmax function to the scores, and select an emotion label based on a maximum probability.

7. The system according to claim 6, wherein the circuitry is configured to adjust at least one of a volume level, a speaking speed, or a notification frequency of the audio output data based on the emotion label and the scores.

8. The system according to claim 1, wherein the circuitry is configured to calculate the relevance value by computing a proximity score, an urgency score, an emotion-adjusted relevance score, and a preference match score for each acquired data item, and combining the scores using a weighted sum or a non-linear function to produce a presentation priority value.

9. The system according to claim 1, wherein the environment data comprises at least one of weather data, transportation data, or facility data, and the service data comprises at least one of promotional data or event data associated with the region data.

10. The system according to claim 1, wherein the circuitry is configured to invoke a text-to-speech engine to synthesize an audio waveform from the presentation target data, adjust an amplitude and a dynamic range of the audio waveform based on user hearing preference data, and convert the audio waveform into the vibration signal via a digital-to-analog converter for output to the actuator.

11. The system according to claim 1, wherein the actuator comprises a bone-conduction actuator configured to produce mechanical vibrations that propagate through bone to an inner ear of the user.

12. The system according to claim 1, wherein the input prompt comprises a natural language description of the position state, the emotion label, a current notification rule configuration, and an optimization goal, and wherein the response from the generative language model comprises at least one of updated scoring weights, category priorities, notification rate parameters, or message template data.

13. The system according to claim 1, wherein the circuitry is configured to suppress the presentation target data having a priority below a threshold when an emotion-derived stress index of the user exceeds a predetermined stress threshold.

14. The system according to claim 1, wherein the circuitry is configured to scan a plurality of wireless access point signals receivable at the position of the user, compute a signal strength vector from the scanned signals, compare the signal strength vector with stored reference signal strength vectors associated with known regions, and determine the region data based on a closest matching reference signal strength vector.

15. The system according to claim 2, wherein the circuitry is configured to determine, based on the movement speed and the movement direction in the position history data, a movement context of the user as one of a stationary state, a walking state, or a vehicular state, and to suppress presentation of the presentation target data requiring visual attention when the movement context corresponds to the vehicular state.

16. The system according to claim 1, wherein the circuitry is configured to perform the speech recognition processing by computing, frame by frame, a probability distribution over phonetic units using a neural acoustic model, and performing decoding with a beam search algorithm to obtain a text sequence.

17. The system according to claim 1, wherein the circuitry is configured to transmit, to a server via the packet-switched network, state data comprising the position history data, the extracted keyword, and emotion data, and to receive, from the server, the presentation target data selected based on the state data.

18. A system comprising:
circuitry configured to:
acquire, via a communication interface coupled to a packet-switched network, an audio signal from an acoustic sensor, convert the audio signal into a digital signal, segment the digital signal into frames, apply a window function to each frame, and compute a short-time Fourier transform to obtain a complex spectrum;
estimate a noise power spectrum from the complex spectrum, suppress a noise component by attenuating the noise power spectrum in each frequency bin, and generate a processed speech signal in which the noise component is suppressed and a speech component is emphasized;
compute, for each frame, mel-frequency cepstral coefficients, log-mel filterbank energies, frame energy, spectral centroid, and fundamental frequency, and concatenate per-frame feature vectors into a time-series feature array;
perform speech recognition processing on the processed speech signal using a neural acoustic model to compute a probability distribution over phonetic units and a beam search decoder to obtain a text sequence, extract a keyword based on a stored keyword group, and identify a speech section including the keyword;
convert the identified speech section into a vibration signal and output the vibration signal to a bone-conduction actuator configured to produce mechanical vibrations that propagate through bone to an inner ear of a user;
calculate a position of the user based on at least one of a satellite positioning signal, a wireless communication signal, or an output of an inertial sensor, determine a position state, and acquire environment data and service data from an external information source via the packet-switched network based on the position state;
calculate a relevance value for each acquired data item by computing a proximity score, an urgency score, an emotion-adjusted relevance score, and a preference match score and combining the scores to produce a presentation priority value, and select presentation target data based on the presentation priority value;
input the time-series feature array into an emotion estimation neural network comprising at least one recurrent or attention-based layer, compute scores for a plurality of predefined emotion categories, and select an emotion label;
generate combined audio data by mixing audio output data derived from the presentation target data with the processed speech signal for output via the bone-conduction actuator, and adjust at least one of a volume level, a speaking speed, or a notification frequency of the audio output data based on the emotion label; and
construct an input prompt comprising the position state, the extracted keyword, the emotion label, and the acquired data, transmit the input prompt to a generative language model, receive a response, and update at least one of the audio output data or a ranking condition based on the response.

19. The system according to claim 18, wherein the circuitry is further configured to suppress the presentation target data having a priority below a threshold when an emotion-derived stress index of the user exceeds a predetermined stress threshold.

20. A method performed by circuitry of a system, the method comprising:
acquiring, via a communication interface coupled to a packet-switched network, an audio signal from an acoustic sensor, converting the audio signal into a digital signal, and storing the digital signal in a memory;
segmenting the digital signal into time-domain and frequency-domain frames, performing short-time spectral analysis, and generating a processed speech signal in which a noise component is suppressed and a speech component is emphasized;
detecting a speech section in the processed speech signal, performing speech recognition processing, extracting a keyword based on a stored keyword group, and identifying the speech section including the keyword;
converting the identified speech section into a vibration signal and outputting the vibration signal to an actuator;
calculating a position of a user, generating position history data, determining a position state, and acquiring environment data and service data from an external information source via the packet-switched network based on the position state;
calculating a relevance value for each acquired data item, ranking and selecting presentation target data, and generating combined audio data by mixing audio output data with the processed speech signal; and
constructing an input prompt comprising the position state, the extracted keyword, and the acquired data, transmitting the input prompt to a generative language model, receiving a response, and updating at least one of the audio output data or a ranking condition based on the response.
